(19) United States
(12) Patent Application Publication
(10) Pub. No.: US 2023/0418284 A1
(43) Pub. Date: Dec. 28, 2023

(54) REMOTE-CONTROL APPARATUS, REMOTE-CONTROLLED VEHICLE, REMOTE-CONTROL SYSTEM, AND REMOTE-CONTROL PROGRAM

(71) Applicant: DENSO CORPORATION, Kariya-city (JP)

(72) Inventor: Masatake ISHIKAWA, Kariya-city (JP)

(21) Appl. No.: 18/464,010

(22) Filed: Sep. 8, 2023

Related U.S. Application Data
(63) Continuation of application No. PCT/JP2022/002608, filed on Jan. 25, 2022.

(30) Foreign Application Priority Data
Mar. 11, 2021 (JP) 2021-039612

(51) Int. Cl. G05D 1/00; G07C 5/00

(52) U.S. Cl. CPC G05D 1/0011; G07C 5/008

(57) ABSTRACT

In a remote-control apparatus, a receiver receives, from a vehicle, vehicle condition information representing a condition of the vehicle and a surrounding condition around the vehicle. An accepting unit presents the vehicle condition information to a remote operator, and accepts assistance information for remote assistance of the vehicle inputted by the remote operator. A determiner determines an expiration term of the assistance information. The expiration term of the assistance information is defined as an end time of an assistance-information valid period that has started since an input time of the assistance information. A sender sends, to the vehicle, the assistance information and the expiration term of the assistance information.

### REFERENCE TO RELATED APPLICATIONS

This application is a bypass continuation application of currently pending international application No. PCT/JP2022/002608 filed on Jan. 25, 2022 designating the United States of America, the entire disclosure of which is incorporated herein by reference, the international application being based on and claiming the benefit of priority from Japanese Patent Application No. 2021-039612 filed on Mar. 11, 2021, the disclosure of which is incorporated in its entirety herein by reference.

### TECHNICAL FIELD

The present disclosure relates to remote-control apparatuses, remote-controlled vehicles, remote-control systems, and remote-control programs.

### BACKGROUND OF THE INVENTION

All vehicle driving processes, which include recognitions, determinations, and operations, are difficult to perfectly automate. From this viewpoint, remote assist systems have been proposed. In such a remote assist system, in response to receiving a request from an autonomous vehicle, a remote operator outputs, to the autonomous vehicle, assistance information through a remote assist apparatus, so that the autonomous vehicle performs a final security verification task, and thereafter, executes remotely assisted operations in accordance with the assistance information.

Delays in communication through the remote assist system may cause the condition of the autonomous vehicle and the surrounding condition around the autonomous vehicle, which have been recognized by the remote operator for generating the assistance information, to be different from the actual condition of the autonomous vehicle and the surrounding condition around the autonomous vehicle. This may result in a remote-control action, which is contrary to remote-operator's intension, being carried out.

Japanese Patent Application Publication NO. 2019-83462 discloses an industrial-vehicle telemanipulation system. The industrial-vehicle telemanipulation system disclosed in the patent publication includes (i) an industrial vehicle equipped with a vehicle communication unit, and (ii) a telemanipulation apparatus equipped with a remote communication unit that communicates, by radio waves, with the vehicle communication unit. In particular, the industrial-vehicle telemanipulation system disclosed in the patent publication includes a technology that addresses delays in communication therethrough.

Specifically, the industrial-vehicle telemanipulation system calculates a delay time of a remote manipulation signal sent from the remote communication unit, and determines, based on the delay time of the remote manipulation signal, whether there are delays in communication therethrough. The industrial-vehicle telemanipulation system addresses, in response to determining that there are delays in communication therethrough, the delays in communication therethrough.

### SUMMARY OF THE INVENTION

In the industrial-vehicle telemanipulation system disclosed in the patent publication, a remote operator near a forklift as the industrial vehicle remotely manipulates the forklift to perform cargo handling operations using the forklift while monitoring motion of the forklift. That is, the forklift itself, i.e., the industrial vehicle itself, is configured not to perform recognitions and determinations.

In contrast, the above remote assist system is configured such that the autonomous vehicle performs a final safety verification task therearound before execution of a remote-control action. The time before execution of a remote-control action after reception of the assistance information, which is, for example, the time required for the safety verification task, such as confirmation of surrounding vehicles, may cause the actual condition of the autonomous vehicle and the surrounding condition around the autonomous vehicle to change.

For this reason, merely addressing delays in communication through such an autonomous-vehicle remote assist system may result in a remote-control action, which is contrary to remote-operator's intension, being carried out.

In such an autonomous-vehicle remote assist system, the autonomous vehicle transmits, to a remote-control apparatus for remotely controlling the autonomous vehicle, information about the condition thereof and the surrounding condition therearound. For this reason, delays may occur in bidirectional communications between the autonomous vehicle and the remote-control apparatus.

The present disclosure therefore aims to provide remote-control apparatuses, remote-controlled vehicles, remote-control systems, and remote-control programs, each of which enables a vehicle to carry out a remote-control action intended by a remote operator who remotely controls the vehicle.

A remote-control apparatus according to a first exemplary measure of the present disclosure includes a receiver configured to receive, from a vehicle, vehicle condition information representing a condition of the vehicle and a surrounding condition around the vehicle. The remote-control apparatus includes an accepting unit configured to present the vehicle condition information to a remote operator, and accept assistance information for remote assistance of the vehicle inputted by the remote operator.

The remote-control apparatus includes a determiner configured to determine an expiration term of the assistance information. The expiration term of the assistance information is defined as an end time of an assistance-information valid period that has started since an input time of the assistance information. The remote-control apparatus includes a sender configured to send, to the vehicle, the assistance information and the expiration term of the assistance information.

A remote-control apparatus according to a second exemplary measure of the present disclosure includes a receiver configured to receive, from a vehicle, (i) vehicle condition information representing a condition of the vehicle and a surrounding condition around the vehicle, and (ii) a generation time of the vehicle condition information. The remote-control apparatus includes an accepting unit configured to present the vehicle condition information to a remote operator, and accept assistance information for remote assistance of the vehicle inputted by the remote operator. The remote-control apparatus includes a determiner configured to determine

(I) A first expiration term of the vehicle condition information, the first expiration term of the vehicle condition information being defined as an end time of a first valid period that has started since the generation time of the vehicle condition information

(II) A second expiration term of the assistance information, the second expiration term of the assistance information being separated from the first expiration term of the vehicle condition information and defined as an end time of a second valid period that has started since an input time of the assistance information

The remote-control apparatus includes a sender configured to send, to the vehicle, the assistance information and the second expiration term of the assistance information upon determination that the assistance information has been inputted to the remote-control apparatus by the first expiration term.

A remote-controlled vehicle according to a third exemplary measure of the present disclosure includes a sender configured to send, to a remote-control apparatus, vehicle condition information representing a condition of the remote-controlled vehicle and a surrounding condition around the remote-controlled vehicle. The remote-controlled vehicle includes a receiver configured to receive, from the remote-control apparatus, (i) assistance information for remote assistance of the remote-controlled vehicle inputted by a remote operator, and (ii) an expiration term of the assistance information. The expiration term of the assistance information is defined as an end time of an assistance-information valid period that has started since an input time of the assistance information.

The remote-controlled vehicle includes an executing unit configured to execute a remote-control action instructed by the assistance information upon determination that the remote-control action instructed by the assistance information has been executable by the expiration term of the assistance information.

A remote-control system according to a fourth exemplary measure of the present disclosure includes a remote-control apparatus according to the first exemplary measure of the present disclosure, and a remote-controlled vehicle according to the third exemplary measure of the present disclosure.

A program product for a processor according to a fourth exemplary measure of the present disclosure includes a non-transitory computer-readable medium, and a set of computer program instructions embedded in the computer-readable medium. The instructions cause the processor to

(I) Receive, from a vehicle, vehicle condition information representing a condition of the vehicle and a surrounding condition around the vehicle

(II) Present the vehicle condition information to a remote operator

(III) Accept assistance information for remote assistance of the vehicle inputted by the remote operator

(IV) Determine an expiration term of the assistance information, the expiration term of the assistance information being defined as an end time of an assistance-information valid period that has started since an input time of the assistance information

(V) Send, to the vehicle, the assistance information and the expiration term of the assistance information

Each of the remote-control apparatuses, the remote-controlled vehicle, the remote-control system, and the program product causes, under remote control of the remote operator located at a distinct location, the vehicle to execute the remote-control action that the remote operator is intended to execute.

### BRIEF DESCRIPTION OF THE DRAWINGS

The above object, other objects, characteristics, and advantageous benefits of the present disclosure will become apparent from the following description with reference to the accompanying drawings in which:

FIG. 1 is a block diagram illustrating an example of a configuration of a remote-control system;

FIG. 2 is a block diagram illustrating an example of a hardware configuration of a vehicle;

FIG. 3 is a block diagram illustrating an example of a hardware configuration of a remote-control apparatus;

FIG. 4 is a block diagram illustrating an example of a hardware configuration of a terminal apparatus;

FIG. 5 is a functional block diagram illustrating an example of a functional configuration of the remote-control system;

FIG. 6 is a sequence diagram illustrating an example of a sequence of operations carried out in the remote-control system;

FIG. 7 is a flowchart illustrating an example of a flow of a first control module of a remote-control routine carried out by the remote-control apparatus according to the first embodiment;

FIG. 8 is a diagram illustrating a first exemplary method of determining whether assistance information has been inputted by the expiration term of vehicle condition information;

FIG. 9 is diagram illustrating a second exemplary method of determining whether the assistance information has been inputted by the expiration term of the vehicle condition information;

FIG. 10 is a schematic diagram illustrating expiration-term determining table groups;

FIG. 11 is a flowchart illustrating an expiration term determining subroutine;

FIG. 12 is a flowchart illustrating an example of a flow of a second control module of the remote-control routine carried out by a sender vehicle according to the first embodiment;

FIG. 13 is a flowchart illustrating an example of a flow of a first control module of a remote-control routine carried out by a remote-control apparatus according to the second embodiment;

FIG. 14 is a schematic diagram illustrating expiration-term determining table groups;

FIG. 15 is a flowchart illustrating an expiration term determining subroutine for the vehicle condition information;

FIG. 16 is a sequence diagram illustrating an example of a sequence of operations carried out in a remote-control system according to the third embodiment;

FIG. 17 is a flowchart illustrating an example of a flow of a first control module of a remote-control routine carried out by a remote-control apparatus according to the third embodiment;

FIG. 18 is a flowchart illustrating an example of a flow of a second control module of the remote-control routine carried out by a sender vehicle according to the third embodiment;

FIG. 19 is a flowchart illustrating an example of an expiration term determining subroutine for determining a second valid period of assistance information according to the fourth embodiment; and

FIG. 20 is a flowchart illustrating an example of an expiration term determining subroutine for determining a second valid period of assistance information according to the fifth embodiment.

### DETAILED DESCRIPTION

The following describes exemplary embodiments of the present disclosure with reference to the accompanying drawings.

Remote-control systems according to the present disclosure are configured such that a remote operator provides, in response to an assistance request from an autonomous vehicle that autonomously travels, which will be referred to as a vehicle, remote assistance to the vehicle as an assist target; the remote assistance for example indicates proper timing for the autonomous vehicle to pass over a preceding vehicle or to perform lane change. Vehicles that receive remote assistance will be referred to as remote-controlled vehicles.

### First Embodiment

### Remote-Control System

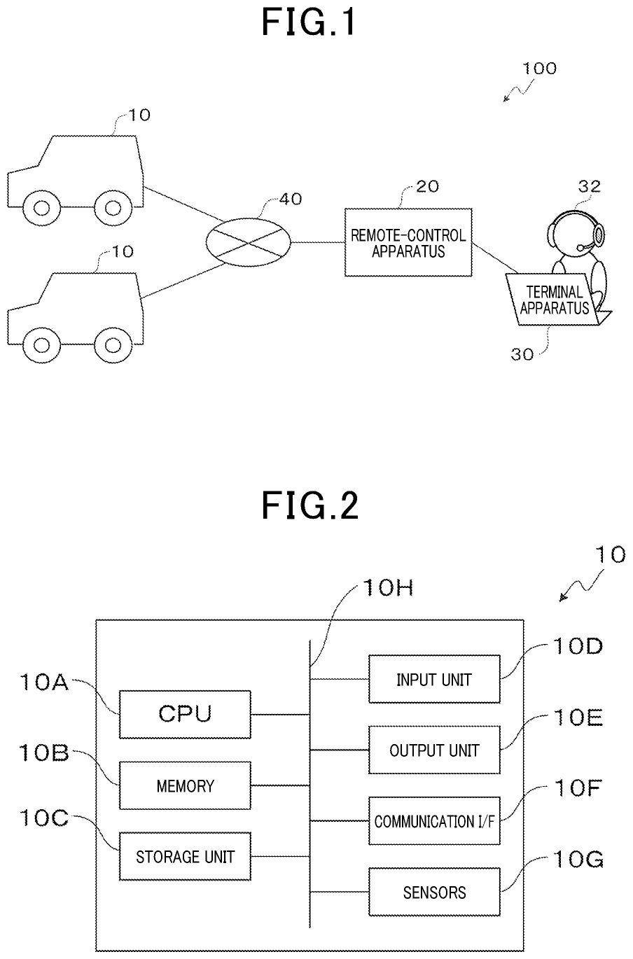

A remote-control system 100 includes, as illustrated in FIG. 1, vehicles 10, a remote-control apparatus 20, and a terminal apparatus 30. The remote-control apparatus 20 is installed in a control center or a cloud. The terminal apparatus 30 can be operated by remote operators. FIG. 1 illustrates an example of the remote-control system 100, which includes two vehicles 10, one remote-control apparatus 20, and one terminal apparatus 30, and therefore the remote-control system 100 can include one or more vehicles 10, one or more remote assist apparatuses 20, and one or more terminal apparatuses 30. The vehicles 10 can travel on any place, the remote-control apparatus 20 can be located at any place, and the terminal apparatus 30 can be located at any place.

Each vehicle 10 is communicably connected to a network 40, which is an example of a public network, such as the internet®, through unillustrated wireless base stations. Each vehicle 10 communicates with the remote-control apparatus 20 connected to the network 40 by radio. The remote-control apparatus 20 and the terminal apparatus 30 are communicably connected to each other through a LAN or another network. This enables the remote-control apparatus 20 and the terminal apparatus 30 to communicate with each other by wire and/or by radio.

Each vehicle 10 includes unillustrated control functions for performing autonomous driving control. The control functions installed in each vehicle 10 perform autonomous driving that controls each mechanism of the corresponding vehicle 10 to cause the corresponding vehicle 10 to autonomously travel in accordance with a previously determined route to a specified destination. If each vehicle 10 requires assistance by a remote operator 32, the corresponding vehicle 10 sends, to the remote-control apparatus 20, a remote assistance request. The sender vehicle 10 also sends, to the remote-control apparatus 20, vehicle condition information representing the condition of the sender vehicle 10 and the surrounding condition around the sender vehicle 10.

The remote-control apparatus 20 is configured to perform remote assistance to each vehicle 10. In response to receiving a remote assistance request from a sender vehicle 10, the remote-control apparatus 20 obtains, from the sender vehicle 10, the vehicle condition information, and presents the vehicle condition information to the remote operator 32, thus prompting the remote operator 32 to enter any assistance information. Specifically, the remote operator 32 operates the terminal apparatus 30 to accordingly input assistance information for remotely assisting the sender vehicle 10.

When receiving the vehicle condition information from a sender vehicle 10, the remote-control apparatus 20 determines an expiration term of the vehicle condition information, and determines an expiration term of the assistance information.

Specifically, if the assistance information is inputted through the terminal apparatus 30 to the remote-control apparatus 20 by the expiration term of the vehicle condition information, the remote-control apparatus 20 is configured to send, to the sender vehicle 10, the inputted assistance information. Otherwise, if the assistance information inputted through the terminal apparatus 30 to the remote-control apparatus 20 has past the expiration term of the vehicle condition information, the remote-control apparatus 20 is configured to abandon the inputted assistance information.

When receiving the assistance information from the remote-control apparatus 20, the sender vehicle 10 determines whether the sender vehicle 10 is able to perform a remote-control action, i.e., remote-control operations, based on the assistance information. When determining that the sender vehicle 10 is able to perform a remote-control action based on the assistance information, the sender vehicle 10 predicts an execution time of the remote-control action based on the assistance information. Then, the sender vehicle 10 is configured to determine whether the sender vehicle 10 is able to execute the remote-control action based on the assistance information by the expiration term of the assistance information, and execute the remote-control action based on the assistance information when determining that the sender vehicle 10 is able to execute the remote-control action based on the assistance information by the expiration term of the assistance information. Otherwise, the sender vehicle 10 is configured to abandon the inputted assistance information when determining that the sender vehicle 10 is unable to execute the remote-control action based on the assistance information by the expiration term of the assistance information.

### Hardware Configuration

Each vehicle 10 includes, as illustrated in FIG. 2, a Central Processing Unit (CPU) 10A, a memory 10B, a storage unit 10C, an input unit 10D, an output unit 10E, a communication interface (I/F) 10F, and sensors 10G. These components 10A to 10G are communicably connected to one another through a bus 10H. For example, one or more electronic control units (ECUs) installed in each vehicle 10 can implement the components 10A to 10G.

The CPU 10A is configured to run various programs and control the components 10B to 10G. Specifically, the CPU 10A is configured to load various programs stored in the storage unit 10C into the memory and run the various programs in the memory 10B that serves as a workspace. Specifically, the CPU 10A is configured to control the components 10B to 10G and perform various tasks in accordance with the various programs stored in the storage unit 10C.

The memory 10B is comprised of a Random Access Memory (RAM), and serves as a workspace that stores temporarily programs and/or data. The storage unit 10C is comprised of, for example, a Read Only Memory, a Hard Disk Drive (HDD), and/or a Solid State Drive (SSD), and stores various programs including an operating system and various data items. In particular, program instructions for executing a remote-control execution task described later are stored in the storage unit 10C.

Each of the input unit 10D and output unit 10E is configured as a Human Machine Interface (HMI). Specifically, the input unit 10D includes various types of input devices, such as switches, a steering wheel, pedals, levers, a sound-recognition input device, and/or a gesture-recognition device, and is configured to input various information items therethrough.

The output unit 10E includes various types of output devices, such as a display, a monitor, meters, and/or speakers, and is configured to output various information items therethrough.

The output unit 10E can be designed to include a touch-panel display, which enables the output unit 10E to serve as at least a part of the input unit 10D.

The communication I/F 10F serves as an interface that enables the components 10A to 10E and external devices to communicate with each other. The communication I/F 10F can be configured to use the internet®, communications standards, such as FDDI and/or Wi-Fi, and/or wide-area wireless communications standards, such as Long Term Evolution (LTE), 4G, and/or 5G.

The sensors 10G of each vehicle 10 include at least one vehicular camera that captures images around the corresponding vehicle 10. The sensors 10G of each vehicle 10 can include one or more millimeter radar devices and/or one or more Light Imaging Detection and Ranging/Laser Imaging Detection and Ranging (LIDAR) sensors, which detect one or more obstacles located around the corresponding vehicle 10. The sensors 10G of each vehicle 10 can include a Global Positioning System (GPS) receiver for measuring the current location of the corresponding vehicle 10, and a microphone for collecting sound around the corresponding vehicle 10.

The remote-control apparatus 20 is comprised of an information processing unit, such as a personal computer and/or a server apparatus.

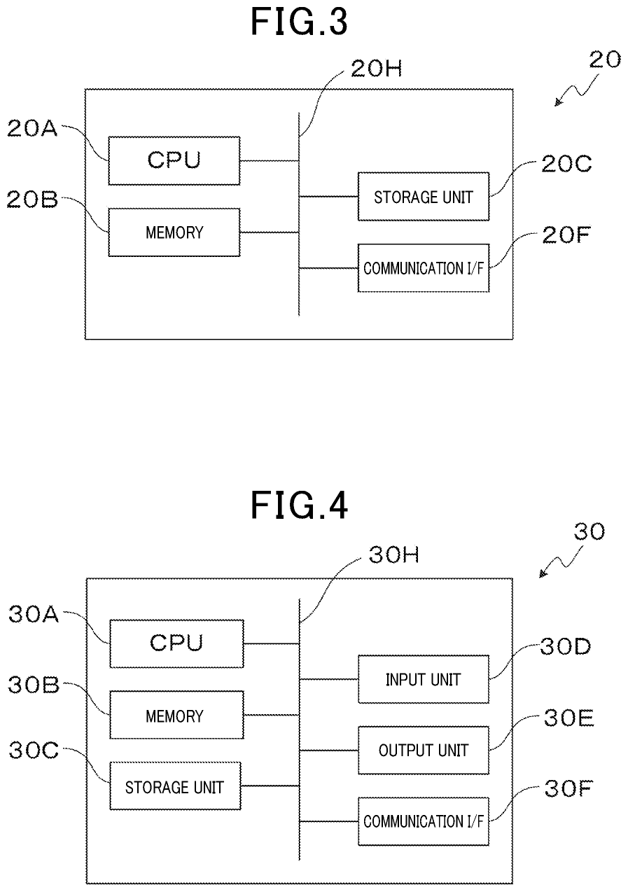

Specifically, the remote-control apparatus 20 includes, as illustrated in FIG. 3, a CPU 20A, a memory 20B, a storage unit 20C, and a communication I/F 20F. These components 20A, 20B, 20C, and 20F are communicably connected to one another through a bus 20H.

Program instructions for executing a remote-control routine described later and various tables used for an expiration setting task are stored in the storage unit 20C. Because the configuration of each of the units 20A, 20B, 20C, and 20F included in the remote-control apparatus is substantially identical to that of the corresponding one of the units 10B, 10C, and 10F, descriptions of the configuration of each of the units 20A, 20B, 20C, and 20F are omitted.

The terminal apparatus 30 is comprised of an information processing unit, such as a personal computer.

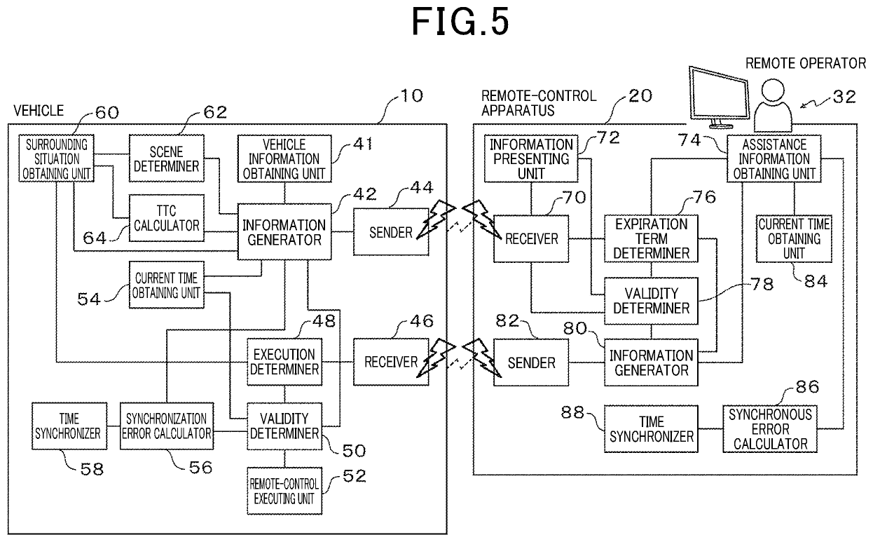

Specifically, the terminal apparatus 30 includes, as illustrated in FIG. 4, a CPU 30A, a memory 30B, a storage unit 30C, an input unit 30D, an output unit 30E, and a communication I/F 30F. These components 30A to 30F are communicably connected to one another through a bus

The input unit 30D, which includes a keyboard, a mouse, and/or other similar input devices, is configured to input various information items therethrough.

The output unit 30E, which includes a display, a printer, and/or other similar output devices, is configured to output various information items therethrough.

The output unit 30E can be designed to include a touch-panel display, which enables the output unit 30E to serve as at least a part of the input unit 30D. Because the configuration of each of the units 30A to 30F included in the terminal apparatus 30 is substantially identical to that of the corresponding one of the units 10A to 10F, descriptions of the configuration of each of the units 30A to 30F are omitted.

### Functional Configuration of Remote-Control System

Next, the following describes a functional configuration of the remote-control system 100 with reference to FIG. 5.

In particular, the following describes a functional configuration of each of the vehicle 10 and the remote-control apparatus 20 while a functional configuration of the terminal apparatus 30 is omitted.

### Functional Configuration of Vehicle

Each vehicle 10 functionally includes a vehicle information obtaining unit 41, an information generator 42, a sender 44, a receiver 46, an execution determiner 48, a validity determiner 50, and a remote-control executing unit 52. In addition, each vehicle 10 functionally includes a current time obtaining unit 54, a synchronization error calculator 56, a time synchronizer 58, a surrounding situation obtaining unit 60, a scene determiner 62, and a time to collision (TTC) calculator 64.

The vehicle information obtaining unit 41 of each vehicle 10 is configured to obtain vehicle information that represents the conditions, such as the speed and current location, of the corresponding vehicle 10.

The surrounding situation obtaining unit 60 of each vehicle 10 is configured to obtain video information that represents the conditions of the surrounding, which includes the front, of the corresponding vehicle and obstacle information that includes (ii) a distance of each obstacle relative to the corresponding vehicle 10, and (iii) a speed of each obstacle relative to the corresponding vehicle 10. The video information can include sound information about sounds linked to videos included in the video information.

The scene determiner 62 of each vehicle 10 is configured to determine, based on the surrounding information obtained by the surrounding situation obtaining unit 60, which of traveling scenes the corresponding vehicle 10 is traveling in. The traveling scenes in which each vehicle 10 is traveling include, for example,

(I) A first scene required to get permission of whether the timing of turning right, turning left, or merging with other traffic is suitable

(II) A second scene required to get permission of whether the corresponding vehicle 10 can move forward in response to a temporary traffic light or a semaphore sign

(III) A third scene required to get permission of whether the corresponding vehicle can perform a traffic operation of, for example, passing one or more obstacles

The TTC calculator 64 of each vehicle 10 is configured to calculate, as a TTC, a time required for the corresponding vehicle 10 to avoid collision with at least one selected obstacle.

The information generator 42 of each vehicle 10 is configured to periodically generate first sending information including the vehicle condition information to accordingly output the first sending information to the sender 44. The information generator 42 of each vehicle 10 is also configured to generate second sending information including an assistance request upon it is determined to require remote assistance by the remote operator 32 to accordingly output the second sending information to the sender 44.

Each vehicle 10 and the remote-control apparatus 20 perform packet communications with one another. Specifically, the sender 44 of each vehicle 10 is configured to store the first sending information into at least one packet, and thereafter send the at least one packet to the remote-control apparatus 20. Similarly, the sender 44 of each vehicle 10 is configured to store the second sending information into at least one packet, and thereafter send the at least one packet to the remote-control apparatus 20.

The information generator 42 of each vehicle 10 is configured to

(I) Obtain, from the surrounding situation obtaining unit 60, the video information and the obstacle information from the surrounding situation obtaining unit 60

(II) Obtain, from the scene determiner 62, the determined traveling scene

(III) Obtain, from the TTC calculator 64, the TTC for at least one selected obstacle

(IV) Obtain, from the vehicle information obtaining unit 41, the vehicle information on the corresponding vehicle 10

Then, the information generator 42 of each vehicle 10 is configured to link (i) the video information and the obstacle information, (ii) the determined traveling scene, (iii) the TTC for at least one selected obstacle, and (iv) the vehicle information, which are obtained at the same time, to each other to accordingly generate the vehicle condition information on the corresponding vehicle 10 at the same time.

The current time obtaining unit 54 is configured to obtain, from a clock provided in the corresponding vehicle 10, the current time.

The information generator 42 is configured to, concurrently with generating the vehicle condition information, obtain the current time from the current time obtaining unit 54 to accordingly set a generation time of the vehicle condition information to the obtained current time.

The time synchronizer 58 is configured to obtain standard time.

The synchronization error calculator 56 is configured to calculate, based on the standard time obtained from the time synchronizer 58, a time difference of the clock provided in the corresponding vehicle 10 relative to the standard time at the moment of setting the generation time of the vehicle condition information, that is, calculate a synchronization error in the corresponding vehicle 10.

Specifically, the information generator 42 of each vehicle 10 is configured to periodically generate, as the first sending information, sending information including (i) the vehicle condition information, (ii) the generation time of the vehicle condition information, and (iii) the synchronization error in the corresponding vehicle 10, to accordingly output the first sending information to the sender 44. For example, the sender 44 of each vehicle 10 is configured to store (i) the vehicle condition information, (ii) the generation time of the vehicle condition information, and (iii) the synchronization error in the corresponding vehicle 10 into a single packet as a vehicle-condition packet, and send the vehicle-condition packet to the remote-control apparatus 20.

The receiver 26 of each vehicle 10 is configured to receive an assistance-information packet, which will be described later, from the remote-control apparatus 20; the assistance-information packet includes assistance information in response to an assistance request. The receiver 26 of each vehicle 10 is configured to extract, from the received assistance-information packet, the assistance information, a synchronization error in the remote-control apparatus 20, and the expiration term of the assistance information. The receiver 26 of each vehicle 10 is configured to output, to the execution determiner 48, the extracted information items.

The execution determiner 48 of each vehicle 10 is configured to retrieve, from the surrounding situation obtaining unit 60, the video information that represents the conditions of the surrounding, which includes the front, of the corresponding vehicle 10, and determine whether the corresponding vehicle 10 is able to execute a remote-control action based on the assistance information safely.

The execution determiner 48 of each vehicle 10 calculates, upon determining that the corresponding vehicle 10 is able to execute a remote-control action based on the assistance information safely, a time required to start execution of the remote-control action.

The validity determiner 50 of each vehicle 10 is configured to retrieve, from the execution determiner 48, (i) the time required to start execution of the remote-control action, which will be referred to as a required time, (ii) the synchronization error in the remote-control apparatus 20, and (iii) the expiration term of the assistance information, and additionally retrieve, from the synchronization error calculator 56, the synchronization error in the corresponding vehicle 10. Next, the validity determiner 50 of each vehicle 10 is configured to obtain, from the clock provided in the corresponding vehicle 10, the current time, and predict a future time, which will be the required time later from the current time, as a predicted remote-control action execution time.

The validity determiner 50 of each vehicle 10 is configured to determine, based on the synchronization error in the corresponding vehicle 10 and the synchronization error in the remote-control apparatus whether the corresponding vehicle 10 is able to execute the remote-control action based on the assistance information by the expiration term of the assistance information. The validity determiner 50 of each vehicle is configured to output, to the remote-control executing unit 52, the assistance information and a determination result indicative of whether the corresponding vehicle 10 is able to execute the remote-control action based on the assistance information by the expiration term of the assistance information.

The remote-control executing unit 52 of each vehicle 10 is configured to execute the remote-control action based on the assistance information upon determining that the corresponding vehicle 10 is able to execute the remote-control action based on the assistance information by the expiration term of the assistance information. The remote-control executing unit 52 is configured to abandon the assistance information to accordingly cancel execution of the remote-control action upon determining that the corresponding vehicle 10 is unable to execute the remote-control action based on the assistance information by the expiration term of the assistance information.

### Functional Configuration of Remote-Control Apparatus

The remote-control apparatus 20 functionally includes a receiver an information presenting unit 72, an assistance information obtaining unit 74, an expiration term determiner 76, a validity determiner 78, an information generator 80, and a sender 82. In addition, the remote-control apparatus 20 functionally includes a current time obtaining unit 84, a synchronization error calculator 86, and a time synchronizer 88.

The receiver 70 is configured to receive, from a sender vehicle 10, the at least one packet including the assistance request and the vehicle-condition packet including the vehicle condition information. The receiver is configured to extract, from the at least one packet including the assistance request, the assistance request, and extract, from the vehicle-condition packet, (i) the vehicle condition information, (ii) the generation time of the vehicle condition information, and (iii) the synchronization error in the sender vehicle 10.

Additionally, when receiving the assistance request from the sender vehicle 10, the receiver 70 is configured to output, to the information presenting unit 72, the vehicle condition information. When receiving the assistance request from the sender vehicle 10, the receiver is also configured to output, to the expiration term determiner 76, (i) the determined traveling scene and (ii) the TTC for at least one selected obstacle included in the vehicle condition information, and (iii) the generation time of the vehicle condition information. Moreover, when receiving the assistance request from the sender vehicle 10, the receiver is configured to output, to the validity determiner 78, the synchronization error in the remote-control apparatus 20.

The information showing unit 72 is configured to present the vehicle condition information to the remote operator 32. The remote operator 32 checks, based on the video information included in the vehicle condition information, the conditions of the surrounding, which includes the front, of the sender vehicle 10, and thereafter, inputs assistance information through the terminal apparatus 30 to the remote-control apparatus 20. The assistance information obtaining unit 74 is configured to accept the assistance information inputted by the remote operator 32 through the terminal apparatus 30.

The current time obtaining unit 84 is configured to obtain the current time.

The assistance information obtaining unit 74 is configured to, concurrently with obtaining the assistance information, obtain the current time from the current time obtaining unit 74 to accordingly determine the obtained current time as an input time of the assistance information to the remote-control apparatus 20.

The time synchronizer 88 is configured to obtain standard time.

The synchronization error calculator 86 is configured to calculate, based on the standard time obtained from the time synchronizer 88, a time difference of the clock provided in the remote-control apparatus 20 relative to the standard time at the moment of obtaining the input time of the assistance information, that is, calculate a synchronization error in the remote-control apparatus 20.

The expiration term determiner 76 is configured to determine the expiration term of the vehicle condition information, and determine the expiration term of the assistance information. The expiration term of the vehicle condition information can be set to an end time of a first valid period that has started since the generation time of the vehicle condition information. The expiration term of the assistance information can be set to an end time of a second valid period that has started since the input time of the assistance information. The expiration term determiner 76 is configured to calculate the first and second valid periods.

The expiration term of each of the vehicle condition information and the assistance information can be expressed as the expiration term of “XX time”. The expiration term of, for example, the vehicle condition information can be expressed by the combination of the generation time and the first valid period, such as after YY seconds from the generation time. Similarly, the expiration term of, for example, the assistance information can be expressed by the combination of the input time and the second valid period, such as after ZZ seconds from the input time.

Specifically, the expiration term determiner 76 is configured to calculate the first valid period based on the generation time of the vehicle condition information received by the receiver 70 to accordingly calculate the end time of the first valid period. Then, the expiration term determiner 76 is configured to set the calculated end time of the first valid period as the expiration term of the vehicle condition information.

Similarly, the expiration term determiner 76 is configured to calculate the second valid period based on the input time of the assistance information obtained by the assistance information obtaining unit 74 to accordingly calculate the end time of the second valid period. Then, the expiration term determiner 76 is configured to determine the calculated end time of the second valid period as the expiration term of the assistance information.

The validity determiner 78 is configured to retrieve, from the expiration term determiner 76, the expiration term of the vehicle condition information and the input time of the assistance information. The input time of the assistance information may contain the synchronization error in the remote-control apparatus 20. Specifically, the validity determiner 78 is configured to determine, based on the synchronization error in the corresponding vehicle 10 obtained from the receiver 70 and the synchronization error in the remote-control apparatus 20, whether the assistance information has been inputted by the expiration term of the vehicle condition information. The validity determiner 78 is configured to output, to the information generator 80, a determination result indicative of whether the assistance information has been inputted by the expiration term of the vehicle condition information.

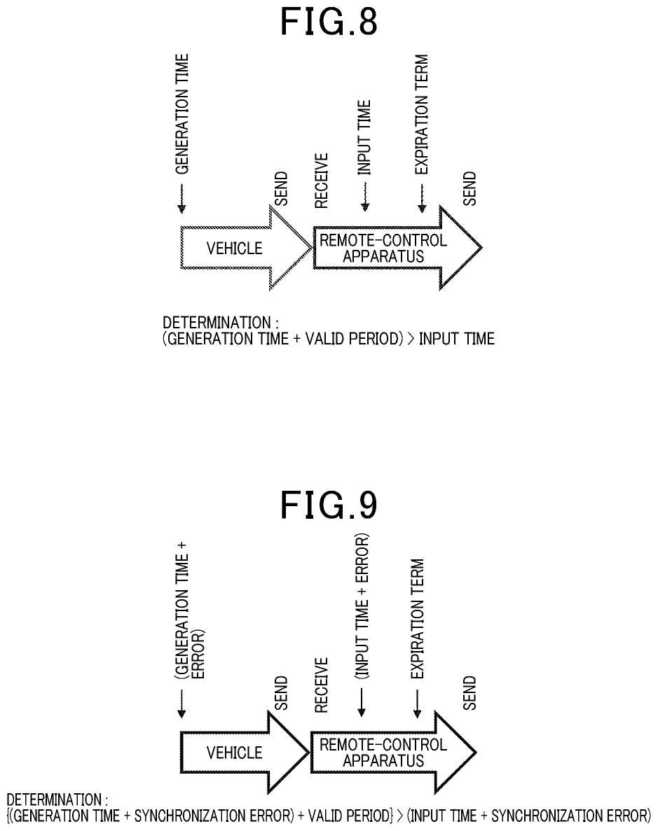

For example, as illustrated in FIG. 8, the sum of the generation time of the vehicle condition information and the first valid period is set to the expiration term of the vehicle condition information. If the input time of the assist information is determined to be earlier than the expiration term of the vehicle condition information based on comparison between the input time of the assist information and the expiration term of the vehicle condition information, the assist information is determined to be inputted to the remote-control apparatus 20 by the expiration term of the vehicle condition information.

Let us consider a case where the synchronous error in each of the sender vehicle 10 and the remote-control apparatus 20, as illustrated in FIG. 9. That is, the synchronous error in the sender vehicle 10 need be added to the generation time of the vehicle condition information, and the synchronization error in the remote-control apparatus 20 need be added to the input time of the assistance information. The synchronous error in each of the sender vehicle 10 and the remote-control apparatus represents a delay from the standard time. For example, if the synchronous error in the sender vehicle 10 is a seconds, an actual generation time of the vehicle condition information is the time, which is a seconds later the generation time of the vehicle condition information.

Specifically, the sum of the generation time of the vehicle condition information, the synchronization error in the sender vehicle 10, and the first valid period is compared to the sum of the input time of the assist information and the synchronous error in the remote-control apparatus 20. If the sum of the input time of the assist information and the synchronous error in the remote-control apparatus 20 determined to be earlier than the sum of the generation time of the vehicle condition information, the synchronization error in the sender vehicle 10, and the first valid period, it is determined that the assist information is inputted to the remote-control apparatus 20 by the expiration term of the vehicle condition information.

It is preferable that determination of whether the generation time or the input time is within the corresponding expiration term is carried out while the accuracy of the generation time or the input time is ensured as set forth above.

Specifically, the information generator 80 is configured to generate, upon the assist information being determined to be inputted to the remote-control apparatus 20 by the expiration term of the vehicle condition information, third sending information that includes (i) the assistance information, (ii) the synchronous error in the remote-control apparatus 20, which are obtained from the assistance information obtaining unit 74, and (iii) the expiration term of the assistance information obtained from the expiration term determiner 76.

Then, the information generator 80 is configured to output, to the sender 82, the third sending information including (i) the assistance information, (ii) the synchronous error in the remote-control apparatus and (iii) the expiration term of the assistance information.

The sender 82 is configured to store (i) the assistance information, (ii) the synchronous error in the remote-control apparatus 20, and (iii) the expiration term of the assistance information into a single packet as the assistance-information packet, and send the assistance-information packet to the sender vehicle 10.

In contrast, the information generator 80 is configured to abandon, upon the assist information being determined not to be inputted to the remote-control apparatus 20 by the expiration term of the vehicle condition information, the assistance information, thus preventing the assistance information obtained from the assistance information obtaining unit 74 from being sent to the sender vehicle 10.

As described above, the remote-control system 100 is configured such that the remote-control apparatus 20 stores (i) the assistance information, (ii) the synchronous error in the remote-control apparatus and (iii) the expiration term of the assistance information into a single packet as the assistance-information packet, and sends the assistance-information packet to the sender vehicle 10 that has sent the assistance request.

Let us assume that the expiration term of the assistance information or information required to set the expiration term of the assistance information will be referred to as expiration term information.

Sending the expiration term information and the assistance information using respective separate packets would result in inconveniences of (i) waiting for the arrival of the expiration term information, (ii) requiring the linkage between the expiration term information and the assistance information, and (iii) previously determining a measure for a case where the expiration term information is lost.

In contrast, sending the expiration term information and the assistance information using a single packet enables these inconveniences to be eliminated.

The above advantageous effect for the expiration term information and the assistance information can be established for the vehicle condition information and its expiration term information.

### Remote-Control Routine

Next, the following describes how the remote-control routine is carried out in the remote-control system 100.

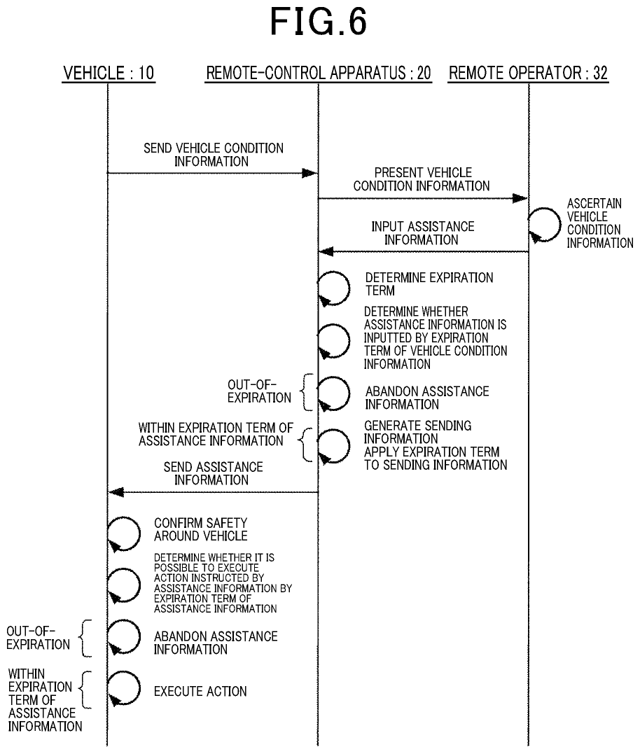

Referring to FIG. 6, each vehicle 10 generates the vehicle condition information and send, to the remote-control apparatus 20, the vehicle condition information at regular intervals, such as 500 milliseconds (ms). If one of the vehicles 10 requires assistance by the remote operator 32, one of the vehicles 10, i.e., a sender vehicle 10, sends, to the remote-control apparatus 20, a remote assistance request.

When receiving the remote assistance request and the vehicle condition information from the sender vehicle 10, the remote-control apparatus 20 presents the vehicle condition information to the remote operator 32, thus prompting the remote operator 32 to enter any assistance information. Specifically, the remote operator 32 operates the terminal apparatus 30 to accordingly input assistance information for remotely assisting the sender vehicle 10.

When accepting the assistance request from the terminal apparatus 30, the remote-control apparatus 20 sets an expiration term for the assistance request. Similarly, when receiving the vehicle condition information from each vehicle 10, the remote-control apparatus 20 sets an expiration term for the vehicle condition information.

If the assistance information is inputted through the terminal apparatus 30 to the remote-control apparatus 20 by the expiration term of the vehicle condition information, the remote-control apparatus 20 sends, to the sender vehicle 10, the inputted assistance information. Otherwise, if the assistance information inputted through the terminal apparatus 30 to the remote-control apparatus 20 has past the expiration term of the vehicle condition information, the remote-control apparatus abandons the inputted assistance information.

When receiving the assistance information from the remote-control apparatus 20, the sender vehicle 10 predicts an execution time of the remote-control action based on the assistance information. Then, the sender vehicle 10 determines whether the sender vehicle 10 is able to execute the remote-control action based on the assistance information by the expiration term of the assistance information, and executes the remote-control action based on the assistance information when determining that the sender vehicle 10 is able to execute the remote-control action based on the assistance information by the expiration term of the assistance information. Otherwise, the sender vehicle 10 abandons the inputted assistance information when determining that the sender vehicle 10 is unable to execute the remote-control action based on the assistance information by the expiration term of the assistance information.

The remote-control routine is comprised of a first control module carried out by the remote-control apparatus 20, and a second control module carried out by each vehicle 10.

### First Control Module Carried Out by the Remote-Control Apparatus 20

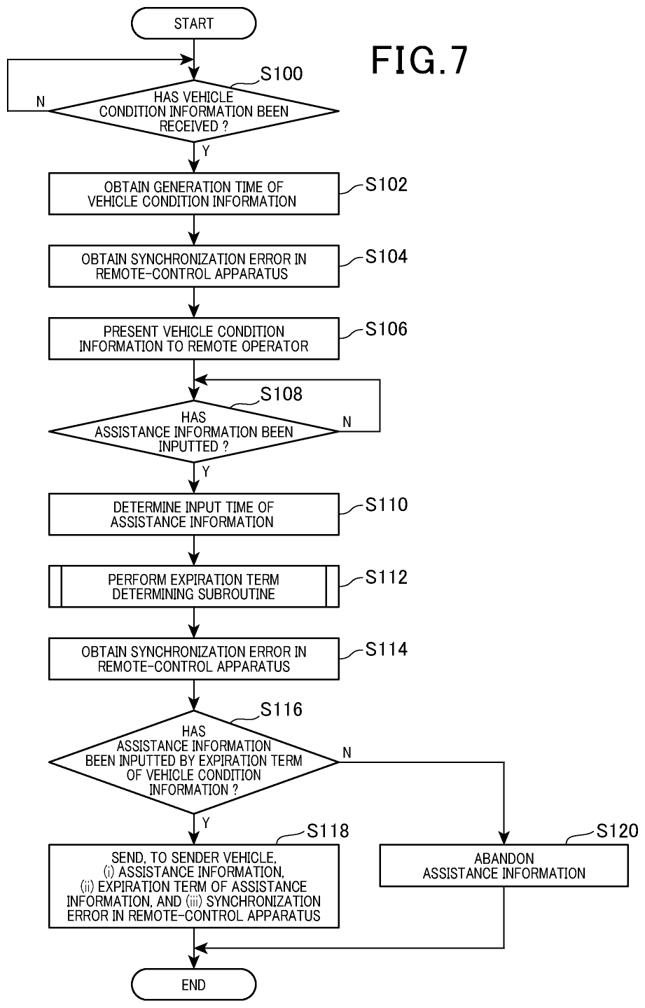

The CPU 20A of the remote-control apparatus 20 is configured to start the first control module of the remote-control routine illustrated in FIG. 7 in response to receiving an assistance request from a sender vehicle 10.

When starting the first control module, the CPU 20A determines whether the CPU 20A has received the vehicle condition information since the receipt of the assistance request in step S100.

Next, when determining that the CPU 20A has received the vehicle condition information from the sender vehicle 10 (YES in step S100), the CPU 20A extracts, from the vehicle condition information, the generation time of the vehicle condition information in step S102. Next, the CPU 20A extracts, from the vehicle condition information, the synchronization error in the sender vehicle 10 in step S104.

Following the operation in step S104, the CPU 20A presents the vehicle condition information to the remote operator 32, thus prompting the remote operator 32 to enter any assistance information in step S106.

Specifically, the CPU 20A determines whether assistance information has been inputted from the remote operator 32 in step S108. When determining that the assistance information is inputted from the remote operator 32 (YES in step S108), the first control module of the remote-control routine proceeds to step S110. Otherwise, when determining that the assistance information has not been inputted yet from the remote operator 32 (NO in step S108), the CPU 20A repeatedly performs the determination of whether assistance information has been inputted from the remote operator 32 in step S108 until input of the assistance information to the remote-control apparatus 20.

When determining that the assistance information is inputted from the remote operator 32 (YES in step S108), the CPU 20A determines the input time of the assistance information to the remote-control apparatus 20 in step S110.

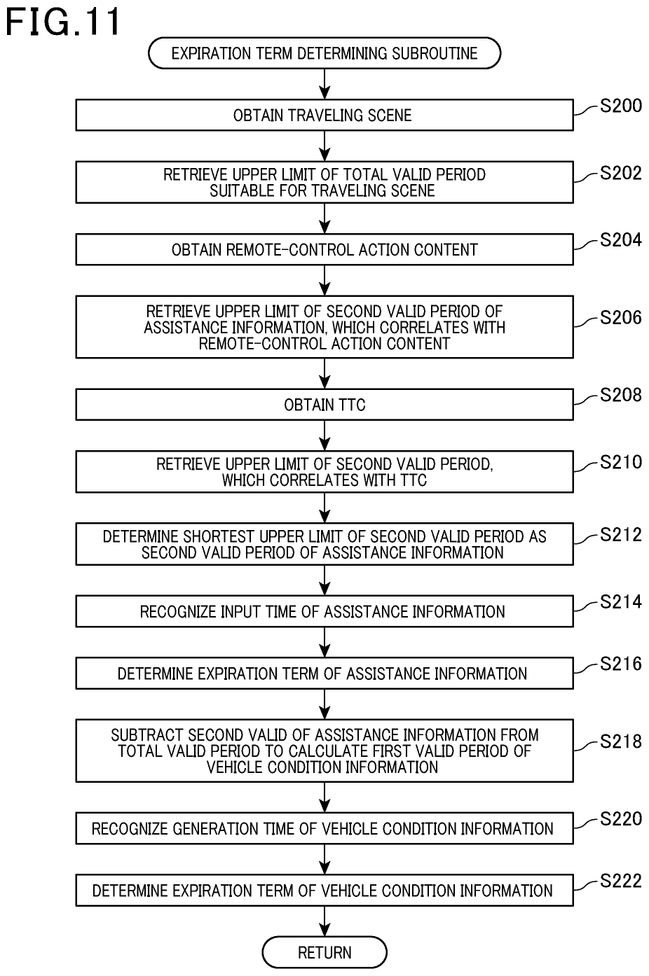

Next, the CPU 20A performs an expiration term determining subroutine based on the generation time of the vehicle condition information and the input time of the assistance information in step S112. For example, the CPU 20A according to the first embodiment is programmed to determine both the expiration term of the vehicle condition information and the expiration term of the assistance information at the same timing. The expiration term determining subroutine will be described in detail later with reference to FIG. 11.

Following the completion of the expiration term determining subroutine in step S112, the CPU 20A obtains the synchronization error in the remote-control apparatus 20 in step S114.

Next, the CPU 20A compares the input time of the assistance information with the expiration term of the vehicle condition information while taking into account both the synchronization error in the sender vehicle and the synchronization error in the remote-control apparatus 20 (see FIG. 9) to accordingly determine whether the assistance information has been inputted to the remote-control apparatus 20 by the expiration term of the vehicle condition information in step S116. When it is determined that the assistance information has been inputted to the remote-control apparatus 20 by the expiration term of the vehicle condition information (YES in step S116), the first control module of the remote-control routine proceeds to step S118. Otherwise, when it is determined that the assistance information has been inputted to the remote-control apparatus 20 after lapse of the expiration term of the vehicle condition information (NO in step S116), the first control module of the remote-control routine proceeds to step S120.

Upon the affirmative determination in step S116, the CPU 20A serves as the sender 82 to send, to the sender vehicle 10, (i) the assistance information, (ii) the synchronous error in the remote-control apparatus 20, and (iii) the expiration term of the assistance information, and thereafter, terminates the first control module of the remote-control routine in step S118.

Otherwise, in response to a negative determination in step S116, the CPU 20A abandons the assistance information, and thereafter terminates the first control module of the remote-control routine in step S120.

### Expiration Term Determining Subroutine

The following describes the expiration term determining subroutine in step S112.

A period for which the remote-control action based on the assistance information is executable; the period, which will be referred to as a third valid period, has started since the generation time of the vehicle condition information.

The third valid period is defined as a period from the generation time of the vehicle condition information to the time of executing the remote-control action based on the assistance in the sender vehicle 10. The third valid period will be therefore also referred to as a total valid period.

The CPU 20A of the first embodiment is programmed to calculate the third valid period as the total valid period and the second valid period as the valid period of the assistance information, and subtract, from the third valid period, the second valid period to accordingly calculate the first valid period as the valid period of the vehicle condition information. For example, assuming that the total valid period is set to 1000 ms and the second valid period is set to 400 ms, the first valid period can be calculated as 600 ms.

Each of the second and third valid periods may vary depending on variation factors.

Specifically, the second valid period can be calculated based on correlations between (I) items of each expiration-term variation factor and (II) corresponding respective upper limits of the second valid period. Similarly, the third valid period can be calculated based on correlations between (I) the items of each expiration-term variation factor and (II) corresponding respective upper limits of the third valid period.

The expiration-term variation factors for each vehicle 10 can include, for example, (i) which of the traveling scenes determined by the corresponding vehicle 10 is currently selected, (ii) which of the remote-control action contents is currently selected by the remote operator 32 through the assistance information for each traveling scene, (iii) the length of a cancellation period for which the remote-control action instructed by the assistance information can be cancelled, (iv) the length of a margin time previously determined for the remote-control action, (v) the extent of the change of the surrounding condition around the corresponding vehicle 10, (vi) the positioning of the remote-control action during the total vehicle control processes, and (vii) the length of the TTC calculated for the corresponding vehicle 10.

The correlations between the items of each expiration-term variation factor and the corresponding respective upper limits of the second valid period can be experimentally determined, and the correlations can be provided in table format. Similarly, the correlations between the items of each expiration-term variation factor and the corresponding respective upper limits of the third valid period can be experimentally determined, and the correlations can be provided in table format.

A set of tables of the correlations between the items of each expiration-term variation factor and the corresponding respective upper limits of the second valid period for each vehicle 10 can be provided for each level of the processing capability of the corresponding vehicle 10, for each level of the processing capability of the remote-control apparatus and/or for each traffic environment around the corresponding vehicle

Which of the traveling scenes currently exists is determined by each vehicle 10, and the determination result indicative of which of the traveling scenes is sent from each vehicle 10 to the remote-control apparatus 20. The traveling scenes, i.e., the traveling scene types, can include

(I) The first scene required to get permission of whether the timing of turning right, turning left, or merging with other traffic is suitable

(II) The second scene required to get permission of whether the corresponding vehicle 10 moves forward in response to a temporary traffic light or a semaphore sign

(III) The third scene required to get permission of whether the corresponding vehicle performs a traffic operation of, for example, passing through one or more obstacles

The upper limit of, for example, the second valid period, which correlates with the first scene, can be set to, for example, one second, the upper limit of the second valid period, which correlates with the second scene, can be set to, for example, several seconds, and the upper limit of the second valid period, which correlates with the third scene, can be set to, for example, a few tens of seconds.

Setting the upper limit of the second valid period correlating with the first scene required for the remote operator 32 to assist the timing of, for example, turning right or left to a shorter value enables the intention of the remote operator 32, i.e., the right-turn timing or left-turn timing, to be efficiently transmitted to the sender vehicle 10. In contrast, the upper limit of the second valid period correlating with the third scene required for the remote operator 32 to get permission of, for example, passing through one or more obstacles, can be set to a longer value. This is because the extent of the change of the surrounding condition around the corresponding vehicle 10 is small. This enables the sender vehicle to, for example, pass, even if slowly, one or more obstacles within the remote-operator's intended situation range.

The remote-control action contents selectable by the remote operator 32 through the assistance information for each traveling scene can include, for example, (i) an instruction of causing the corresponding vehicle 10 to operate, such as go or stop, (ii) information indicative of recognized objects, such as parked vehicles in front of the corresponding vehicle 10, (iii) an instruction indicative of a route or trajectory through which the corresponding vehicle 10 should travel, and (iv) an instruction of remotely driving the corresponding vehicle 10. The remote operator 32 can selectively input, as an item included in the assistance information, one of the remote-control action contents for the selected one of the traveling scenes. That is, the upper limit of, for example, the second valid period can be set to a value for each remote-control action content.

The longer the cancellation period for which the remote-control action instructed by the assistance information can be cancelled, the larger the upper limit of each of the second and third valid periods. The margin time previously determined for the remote-control action represents a permissible time from the receipt of the assistance information to the execution of the remote-control action instructed by the assistance information. The longer the margin time, the larger the upper limit of each of the second and third valid periods. The smaller the extent of the change of the surrounding condition around the corresponding vehicle 10, the larger the upper limit of each of the second and third valid periods.

The total vehicle control processes, which are sequentially carried out, include a recognition process, a determination process, and an operation cycle. The positioning of the remote-control action based on the assistance information during the total vehicle control processes represents information about which of the total vehicle control processes the remote operator 32 intends to assist. If a selected remote-control action instructed by the assistance information, which is earlier more upstream during the total vehicle control processes, than another remote-control action, the selected remote-control action has a longer margin until being executed, making it possible to set a larger upper limit of each of the second and third valid periods for the selected remote-control action.

That is, the upper limits of each of the second and third valid periods can be freely changed as long as they are determined based on various variation factors for each vehicle 10, and therefore, the variation factors cannot be limited to the above examples of the expiration-term variation factors.

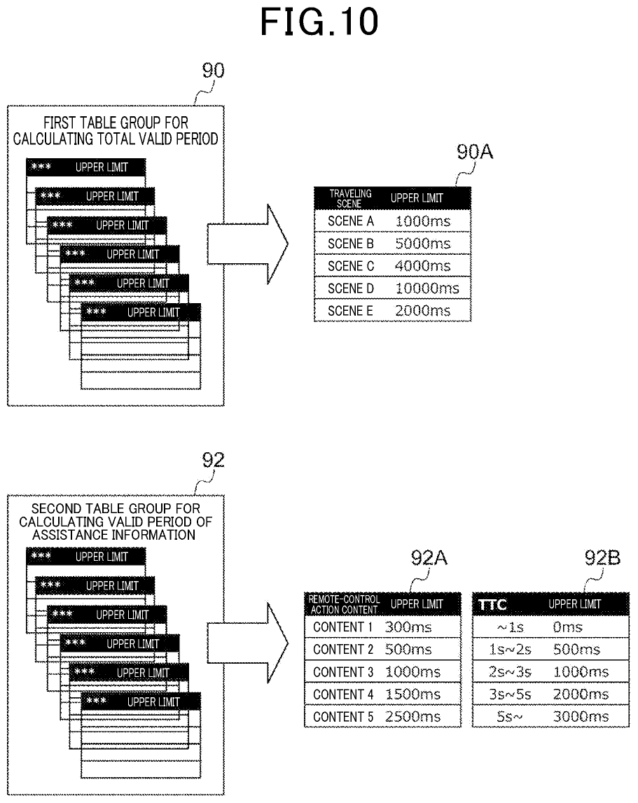

The first embodiment provides, as illustrated in, for example, FIG. 10, (i) a first table group 90 for calculating the third valid period, i.e., the total valid period, and (ii) a second table group 92 for calculating the second valid period, i.e., the valid period of the assistance information. The first and second table groups 90 and 92 are previously stored in the storage unit 20C of the remote-control apparatus 20.

For example, the first table group 90 includes a table 90A that represents a correlation between each traveling scene, i.e., each traveling-scene type, and the corresponding upper limit for the third valid period.

The second table group 92 includes, for example, a table 92A that represents a correlation between each remote-control action content and the corresponding upper limit for the second valid period. Similarly, the second table group 92 includes, for example, a table 92B that represents a correlation between each TTC and the corresponding upper limit for the second valid period.

The expiration term determining subroutine in step S112 is illustrated as a flowchart of FIG. 11.

Referring to FIG. 11, the CPU 20A obtains, from the received vehicle-condition packet of the sender vehicle 10, the determined traveling scene of the sender vehicle as a selected remote-control scene in step S200. Next, the CPU 20A refers to the table 90A to accordingly retrieve, from the table 90A, the upper limit of the third valid period, which correlates with, i.e., is suitable for, the selected remote-control scene, thus determining the retrieved upper limit as the total valid period in step S202.

Following the operation in step S202, the CPU 20A obtains, from the assistance-information packet of the sender vehicle 10, the remote-control action content selected by the remote operator 32 in step S204. Then, the CPU 20A refers to the table 92A to accordingly retrieve, from the table 92A, the upper limit of the second valid period, which correlates with the selected remote-control action content in step S206.

Next, the CPU 20A obtains, from the received vehicle-condition packet of the sender vehicle 10, the TTC for at least one selected obstacle for the sender vehicle 10 in step S208. Next, the CPU 20A refers to the table 92B to accordingly retrieve, from the table 92B, the upper limit of the second valid period, which correlates with the TTC in step S210.

The CPU 20A selects one of the upper limit of the second valid period obtained in step S206 and the upper limit of the second valid period obtained in step S210, which is shorter than the other thereof, thus determining the selected upper limit as the second valid period in step S212.

Next, the CPU 20A recognizes the input time of the assistance information determined in step S108 in step S214. Then, the CPU 20A determines, based on the input time of the assistance information and the determined second valid period, the expiration term of the assistance information in step S216.

Following the operation in step S216, the CPU 20A subtracts, from the total valid period, the second valid period of the assistance information to accordingly calculate the first valid period of the vehicle-condition information in step S218. Next, the CPU 20A recognizes the generation time of the vehicle-condition information extracted in step S102 in step S220.

Then, the CPU 20A determines, based on the generation time of the vehicle-condition information and the first valid period, the expiration term of the vehicle-condition information in step S222, and thereafter terminates the expiration term determining subroutine, returning to the first control module of the remote-control routine.

Execution of the remote-control action in accordance with the remote-operator's intention requires tight control of a period from the input time of the assistance information to the time of executing the remote-control action based on the assistance information. It is therefore preferable to, each time at least one of the expiration-term variation factors varies, determine a value of the second valid period of the assistance information in accordance with a varied value of the at least one of the expiration-term variation factors.

In contrast, a period from the generation time of the vehicle-condition information to the input time of the assistance information to the CPU 20A may be controlled more loosely. This enables the first valid period of the vehicle-condition information to be set to be longer than the second valid period of the assistance information or to a predetermined fixed period. The expiration term can be set for the assistance information with no expiration term set for the vehicle-condition information.

The expiration term of the vehicle-condition information can be set in each vehicle 10. In this case, the expiration term of the vehicle-condition information can be sent from each vehicle 10 to the remote-control apparatus 20 in place of the generation time of the vehicle condition information.

### Second Control Module Carried Out by the Sender Vehicle 10

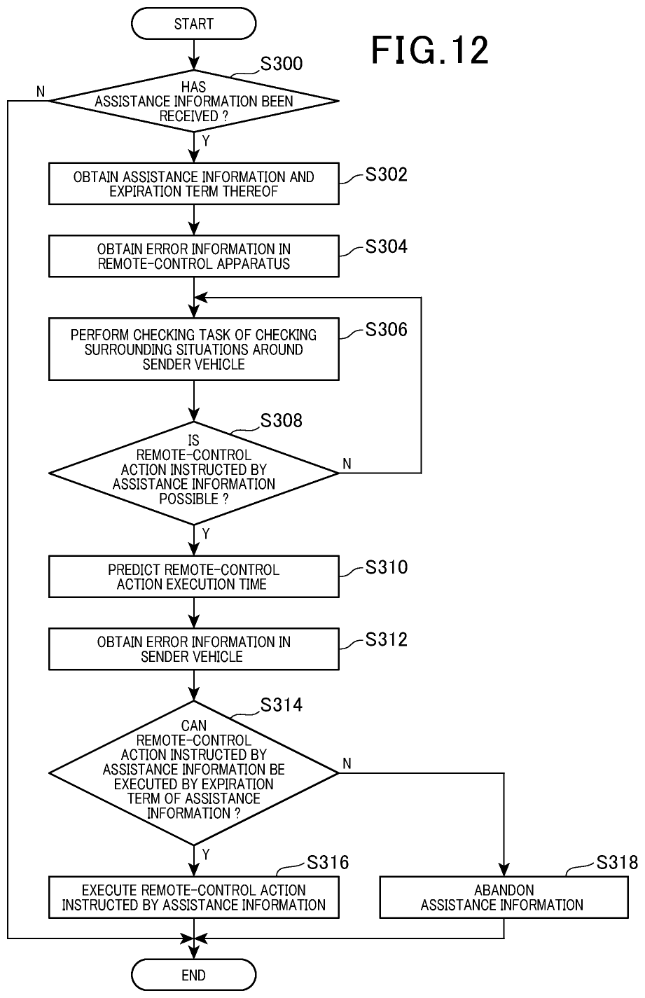

The CPU 10A of the sender vehicle 10 is configured to start the second control module of the remote-control routine illustrated in FIG. 12 in response to receiving any information from the outside.

When starting the second control module, the CPU 10A determines whether the CPU 10A has received the assistance information from the remote-control apparatus 20 in step S300.

When determining that the CPU 20A has received the assistance-information packet from the remote-control apparatus 20 (YES in step S300), the second control module proceeds to step S302. Otherwise, when determining that the CPU 20A has not received the assistance-information packet from the remote-control apparatus 20 (NO in step S300), the CPU 10A determines that the CPU 10A has received information other than the assistance-information packet, and therefore, terminates the second control module of the remote-control routine.

In step S302, the CPU 10A obtains, from the assistance-information packet, the assistance information and the expiration term of the assistance information in step S302. Next, the CPU 10A obtains, from the assistance-information packet, the synchronization error in the remote-control apparatus 20 in step S304.

Next, the CPU 10A retrieves, from the surrounding situation obtaining unit 60, the video information that represents the conditions of the surrounding, which includes the front, of the sender vehicle 10, and performs a checking task of checking the surrounding situations around the sender vehicle 10 in step S306.

Following the operation in step S306, the CPU 10A determines whether the CPU 10A is able to execute the remote-control action instructed by the assistance information safely in step S308. Upon determination that the CPU 10A is able to execute the remote-control action instructed by the assistance information safely (YES in step S308), the second control module of the remote-control routine proceeds to step S310.

Otherwise, upon determination that the CPU 10A is unable to execute the remote-control action instructed by the assistance information safely (NO in step S308), the CPU 10A repeatedly performs the operation in step S306 and the determination in step S308 until the determination in step S308 is affirmative.

In response to the affirmative determination in step S308, the CPU 10A calculates the required time required to start execution of the remote-control action, and predicts a future time, which will be the required time later from the current time, as the predicted remote-control action execution time in step S310.

Next, the CPU 10A obtains the synchronization error in the sender vehicle 10 in step S312.

Next, the CPU 10A compares the predicted remote-control action execution time with the expiration term of the assistance information while taking into account both the synchronization error in the sender vehicle and the synchronization error in the remote-control apparatus 20 to accordingly determine whether the sender vehicle 10 is able to execute the remote-control action instructed by the assistance information by the expiration term of the assistance information in step S314.

The second control module of the remote-control routine proceeds to step S316 upon determination that the sender vehicle 10 is able to execute the remote-control action instructed by the assistance information by the expiration term of the assistance information (YES in step S314), and proceeds to step S318 upon determination that the sender vehicle 10 is unable to execute the remote-control action instructed by the assistance information by the expiration term of the assistance information (NO in step S314).

In response to the affirmative determination in step S314, the CPU 10A executes the remote-control action instructed by the assistance information in step S316, and thereafter terminates the second control module of the remote-control routine. Otherwise, in response to the negative determination in step S314, the CPU 10A abandons the assistance information, and thereafter terminates the second control module of the remote-control routine in step S318.

The remote-control apparatus 20 according to the first embodiment is configured to, under remote control of the remote operator 32 located at a distinct location, cause an assistance-request sender vehicle 10 to execute a remote-control action that the remote operator 32 is intended to execute. The remote-control apparatus 20 according to the first embodiment is configured to cause the assistance-request sender vehicle 10 to abandon the assistance information from the remote operator 32 upon determination that the assistance information is insufficient for the changed situation around the assistance-request sender vehicle 10. This therefore makes it possible for the assistance-request sender vehicle 10 to execute a remote-control action that can respond to the actual situation around the assistance-request sender vehicle 10. This results in an improvement of both the safety and the convenience of each vehicle 10.

### Second Embodiment

The remote-control system of the first embodiment is configured to determine the expiration term of the vehicle-condition information and the expiration term of the assistance information at the same time, but a remote-control system of the second embodiment is configured to respectively determine the expiration term of the vehicle-condition information and the expiration term of the assistance information at the different times.

The configuration of the remote-control system of the second embodiment is substantially identical to that of the remote-control system of the first embodiment except that the method of determining the expiration term of the vehicle-condition information and the expiration term of the assistance information according to the second embodiment is different from that according to the first embodiment. Accordingly, the following describes only the different points of the remote-control system of the second embodiment as compared with the remote-control system of the first embodiment.

### First Control Module Carried Out by the Remote-Control Apparatus 20

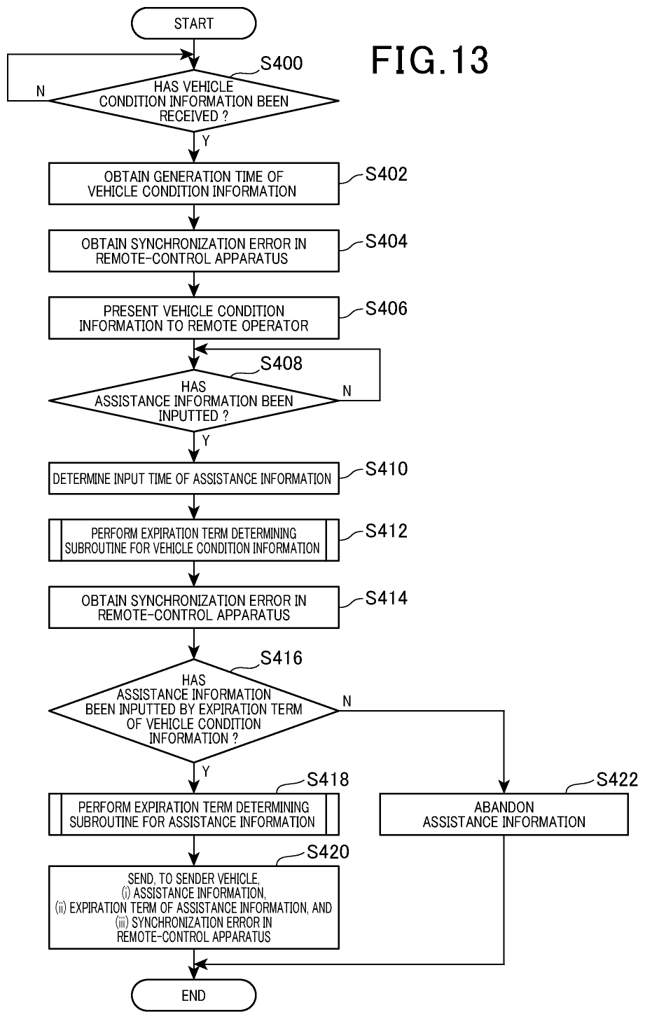

The operations in steps S400 to S410 of the first control module of the remote-control routine according to the second embodiment illustrated in FIG. 13 are identical to the operations in steps S100 to S110 of the first control module of the remote-control routine according to the first embodiment illustrated in FIG. 7, and therefore, the descriptions of the operations in steps S400 to S410 are omitted.

Following the operation in step S410 of the first control module of the remote-control routine according to the second embodiment, the CPU performs an expiration term determining subroutine for the vehicle condition information based on the generation time of the vehicle condition information in step S412. In particular, the CPU 20A according to the second embodiment is configured to calculate the first valid period independently of the second and third valid periods to accordingly determine the expiration term of the vehicle condition information.

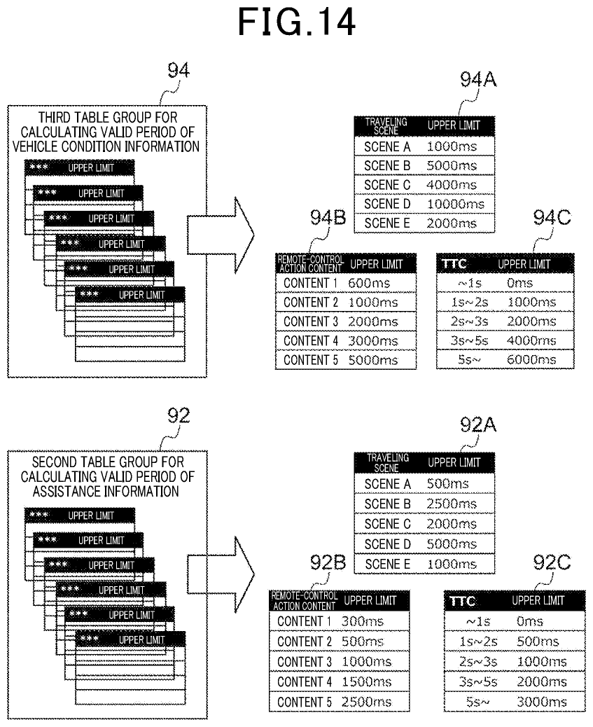

The second embodiment provides, as illustrated in, for example, FIG. 14, a third table group 94 for calculating the first valid period, i.e., the valid period of the vehicle condition information. For example, the third table group 94 includes tables 94A, 94B, and 94C.

The table 94A represents a correlation between each traveling scene, i.e., each traveling-scene type, and the corresponding upper limit for the first valid period. The table 94B represents a correlation between each remote-control action content and the corresponding upper limit for the first valid period. The table 94C represents a correlation between each TTC and the corresponding upper limit for the first valid period.

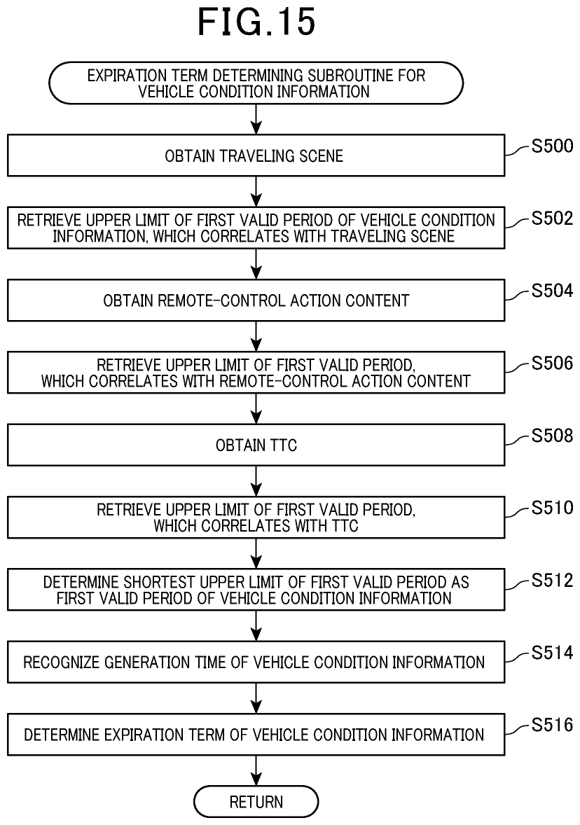

The following describes the expiration term determining subroutine in step S412 with reference to FIG. 15.

Referring to FIG. 15, the CPU 20A obtains, from the received vehicle-condition packet of the sender vehicle 10, the determined traveling scene of the sender vehicle as a selected remote-control scene in step S500. Next, the CPU 20A refers to the table 94A to accordingly retrieve, from the table 94A, the upper limit of the first valid period, which correlates with the selected remote-control scene in step S502.

Following the operation in step S502, the CPU 20A obtains, from the assistance-information packet of the sender vehicle 10, the remote-control action content selected by the remote operator 32 in step S504. Then, the CPU 20A refers to the table 94B to accordingly retrieve, from the table 94B, the upper limit of the first valid period, which correlates with the selected remote-control action content in step S506.

Next, the CPU 20A obtains, from the received vehicle-condition packet of the sender vehicle 10, the TTC for at least one selected obstacle for the sender vehicle 10 in step S508, and refers to the table 94C to accordingly retrieve, from the table 94C, the upper limit of the first valid period, which correlates with the TTC in step S510.

The CPU 20A selects one of the upper limit of the first valid period obtained in step S502, the upper limit of the first valid period obtained in step S504, and the upper limit of the first valid period obtained in step S510, which is shorter than the others thereof, thus determining the selected upper limit as the first valid period in step S512.

Next, the CPU 20A recognizes the generation time of the vehicle-condition information extracted in step S102 in step S514.

Then, the CPU 20A determines, based on the generation time of the vehicle-condition information and the first valid period, the expiration term of the vehicle-condition information in step S516, and thereafter terminates the expiration term determining subroutine, returning to the first control module of the remote-control routine.

Following the completion of the expiration term determining subroutine in step S412, the CPU 20A obtains the synchronization error in the remote-control apparatus 20 in step S414.

Next, the CPU 20A compares the input time of the assistance information with the expiration term of the vehicle condition information while taking into account both the synchronization error in the sender vehicle and the synchronization error in the remote-control apparatus 20 to accordingly determine whether the assistance information has been inputted to the remote-control apparatus 20 by the expiration term of the vehicle condition information in step S416. When it is determined that the assistance information has been inputted to the remote-control apparatus 20 by the expiration term of the vehicle condition information (YES in step S416), the first control module of the remote-control routine proceeds to step S418. Otherwise, when it is determined that the assistance information has been inputted to the remote-control apparatus 20 after lapse of the expiration term of the vehicle condition information (NO in step S416), the first control module of the remote-control routine proceeds to step S422.

Upon the affirmative determination in step S416, the CPU 20A performs an expiration term determining subroutine based on the input time of the assistance information in step S418. In particular, the CPU according to the second embodiment is configured to calculate the second valid period independently of the first and third valid periods to accordingly determine the expiration term of the assistance information.

The second embodiment provides, as illustrated in, for example, FIG. 14, the second table group 92 for calculating the second valid period, i.e., the valid period of the assistance information. For example, the second table group 92 includes tables 92A, 92B, and 92C.

The table 92A represents a correlation between each traveling scene, i.e., each traveling-scene type, and the corresponding upper limit for the second valid period. The table 92B represents a correlation between each remote-control action content and the corresponding upper limit for the second valid period. The table 92C represents a correlation between each TTC and the corresponding upper limit for the second valid period.

Like the expiration term determining subroutine in step S412 with reference to FIG. 15, an expiration term determining subroutine for the assistance information in step S418, which is not illustrated in figures, is configured to

(I) Retrieve, from the table 92A, the upper limit of the second valid period, which correlates with the selected remote-control scene

(II) Retrieve, from the table 92B, the upper limit of the second valid period, which correlates with the selected remote-control action content

(III) Retrieve, from the table 92C, the upper limit of the second valid period, which correlates with the TTC

The CPU 20A selects one of the retrieved upper limits of the second valid period, which is shorter than the others thereof, thus determining the selected upper limit as the second valid period.

Then, the CPU 20A determines, based on the input time of the assistance information and the second valid period, the expiration term of the vehicle-condition information in step S418, and thereafter terminates the expiration term determining subroutine, returning to the first control module of the remote-control routine.

Following the completion of the expiration term determining subroutine in step S418, the CPU 20A serves as the sender 82 to send, to the sender vehicle 10, (i) the assistance information, (ii) the synchronous error in the remote-control apparatus 20, and (iii) the expiration term of the assistance information, and thereafter, terminates the first control module of the remote-control routine in step S420.

Otherwise, when it is determined that the assistance information has been inputted to the remote-control apparatus 20 after lapse of the expiration term of the vehicle condition information (NO in step S416), the CPU 20A abandons the assistance information, and thereafter terminates the first control module of the remote-control routine in step S422.

As described in the first embodiment, the first valid period of the vehicle condition information can be set to be longer than the second valid period of the assistance information or set to a predetermined fixed period.

Like the first embodiment, the remote-control apparatus according to the second embodiment is configured to, under remote control of the remote operator 32 located at a distinct location, cause an assistance-request sender vehicle 10 to execute a remote-control action that the remote operator 32 is intended to execute.

The remote-control apparatus according to the second embodiment is additionally configured to determine

(I) The expiration term of the vehicle condition information based on the first valid period independently of the second and third valid periods

(II) The expiration term of the assistance information based on the second valid period independently of the first and third valid periods

This configuration of the remote-control apparatus according to the second embodiment makes it possible to strictly determine the expiration term of each of the vehicle condition information and the assistance information.

### Third Embodiment

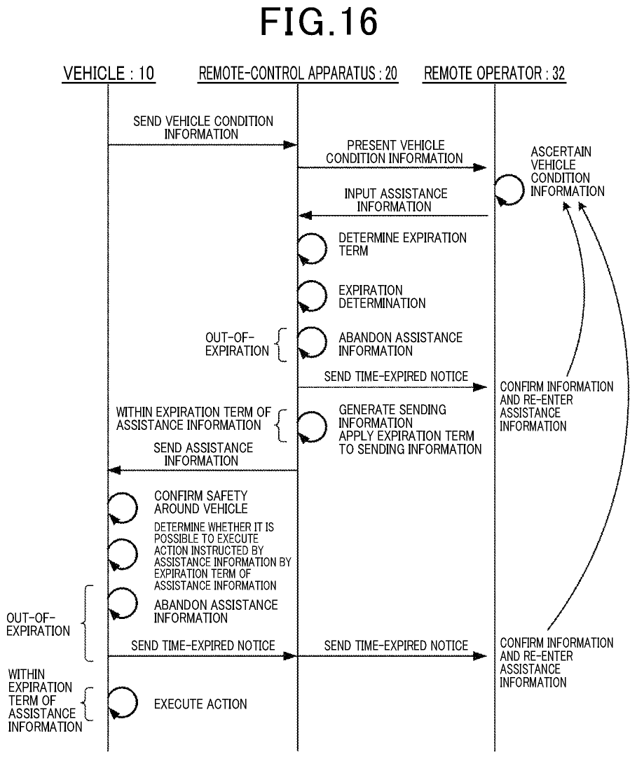

The remote-control apparatus 20 of a remote-control system of the third embodiment is, as illustrated in FIG. 16, configured to, upon determining that the assistance information has been inputted to the remote-control apparatus 20 after lapse of the expiration term of the vehicle condition information, send, to the remote operator 32, a time-expired notice, thus prompting the remote operator 32 to re-enter any assistance information. The sender vehicle 10 of the remote-control system of the third embodiment is configured to, upon determining that the sender vehicle 10 is unable to execute the remote-control action instructed by the assistance information by the expiration term of the assistance information, send, through the remote-control apparatus 20, a time-expired notice to the remote operator 32, thus prompting the remote operator 32 to re-enter any assistance information.

The remote-control apparatus 20 is configured to, each time of receiving the vehicle condition information after having sent the assistance information, present the vehicle condition information to the remote operator 32. When out-of-expiration is notified by the remote-control apparatus 20, the remote operator 32 re-enters new assistance information related to the latest vehicle condition information. This re-entering operation of new assistance information is repeated until the remote-control action instructed by the latest re-entered assistance information is carried out by the sender vehicle 10.

The configuration of the remote-control system of the third embodiment is substantially identical to that of the remote-control system of the first embodiment except for operations carried out by the remote-control apparatus 20 and the sender vehicle 10 in response to notification of out-of-expiration. Accordingly, the following describes only the different points of the remote-control system of the third embodiment as compared with the remote-control system of the first embodiment.

First, the following offers a supplementary explanation for some functional blocks of the remote-control system of the third embodiment illustrated in FIG. 5.

The validity determiner 78 of the remote-control apparatus 20 is configured to output, to the information presenting unit 72, a determination result indicative of whether the assistance information has been inputted by the expiration term of the vehicle condition information upon determination that the assistance information has been inputted after lapse of the expiration term of the vehicle condition information.

The information presenting unit 72 is configured to present, to the remote operator 32, a message showing a time-expired notice of the vehicle condition information, thus prompting the remote operator 32 to re-enter any assistance information.

The validity determiner 50 of the sender vehicle 10 is configured to output, to the information generator 42, a determination result indicative of whether the corresponding vehicle 10 is able to execute the remote-control action based on the assistance information by the expiration term of the assistance information upon determination that the sender vehicle 10 is unable to execute the remote-control action by the expiration term of the assistance information.

The information generator 42 of the sender vehicle 10 is configured to generate, as third sending information, a time-expired notice of the assistance information, and output the third sending information to the sender 44. The sender 44 of the sender vehicle 10 is configured to send the third sending information to the remote-control apparatus 20.

The receiver 70 of the remote-control apparatus 20 is configured to receive the third sending information, and output the received third sending information to the information presenting unit 72.

The information presenting unit 72 is configured to represent, to the remote operator 32, a message showing a time-expired notice of the assistance information, thus prompting the remote operator 32 to re-enter any assistance information.

### First Control Module Carried Out by the Remote-Control Apparatus 20

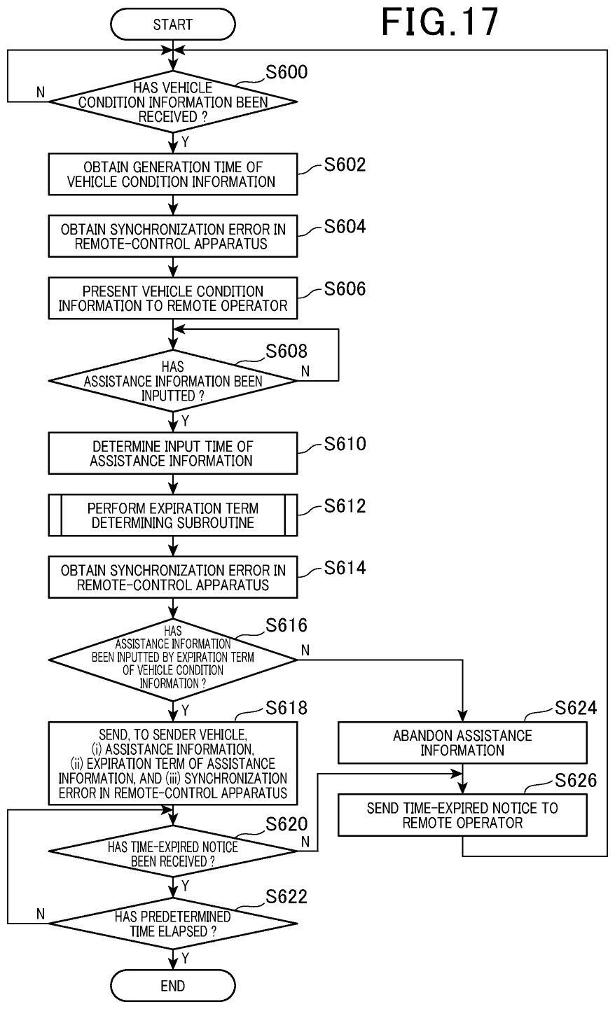

Next, the following describes a flow of the first control module of the remote-control routine carried out by the remote-control apparatus according to the third embodiment with reference to FIG. 17.

Specifically, the remote-control apparatus 20 is configured to perform operations, which are identical to the corresponding operations according to the first embodiment, except for determination that the assistance information has been inputted to the remote-control apparatus 20 after lapse of the expiration term of the vehicle condition information. Thus, description of the operations in steps S600 to S614 before determination of whether the assistance information has been inputted to the remote-control apparatus 20 by the expiration term of the vehicle condition information is omitted, because the operations in steps S600 to S614 are substantially identical to the operations in steps S100 to S114 illustrated in FIG. 7 of the first embodiment.

That is, the following describes operations after determination of whether the assistance information has been inputted to the remote-control apparatus 20 by the expiration term of the vehicle condition information.

Following the operation in step S614, the CPU 20A determines whether the assistance information has been inputted to the remote-control apparatus 20 by the expiration term of the vehicle condition information in step S616.

When it is determined that the assistance information has been inputted to the remote-control apparatus 20 by the expiration term of the vehicle condition information (YES in step S616), the first control module of the remote-control routine proceeds to step S618.

Otherwise, when it is determined that the assistance information has been inputted to the remote-control apparatus 20 after lapse of the expiration term of the vehicle condition information (NO in step S616), the first control module of the remote-control routine proceeds to step S624.

Upon determination that the assistance information has been inputted to the remote-control apparatus 20 after lapse of the expiration term of the vehicle condition information, the CPU 20A abandons the assistance information in step S624. Next, the CPU 20A represents, to the remote operator 32, a time-expired notice in step S626, returning to the operation in step S600, and repeatedly performing the operation in step S600 and the subsequent operations.

The remote operator 32 continuously monitors, after the input of the assistance information, motion of the sender vehicle 10 in accordance with the video information and/or the vehicle information, and enters new assistance information based on the latest vehicle condition information in response to receiving the time-expired notice.

Upon determination that the assistance information has been inputted to the remote-control apparatus 20 by the expiration term of the vehicle condition information, the CPU 20A serves as the sender 82 to send, to the sender vehicle 10, (i) the assistance information, (ii) the synchronous error in the remote-control apparatus 20, and (iii) the expiration term of the assistance information in step S618.

Following the operation in step S618, the CPU 20A determines whether the CPU 20A has received the time-expired notice from the sender vehicle 10 in step S620. Upon determination that the CPU 20A has received the time-expired notice from the sender vehicle 10 (YES in step S620), the CPU 20A presents, to the remote operator 32, a message showing the assistance information being expired, thus sending a time-expired notice to the remote operator 32.

Otherwise, upon determination that the CPU 20A has not received the time-expired notice from the sender vehicle 10 (NO in step S620), the CPU 20A determines whether a predetermined time has elapsed since, for example, the sending of the assistance information in step S622. Upon determination that the predetermined time has elapsed since, for example, the sending of the assistance information (YES in step S622), the CPU 20A determines that the remote-control action instructed by the assistance information has been carried out in the sender vehicle 10, terminating the first control module of the remote-control routine. Otherwise, upon determination that the predetermined time has not elapsed since, for example, the sending of the assistance information (NO in step S622), the CPU 20A returns to step S620, and the CPU 20A determines whether the CPU 20A has received the time-expired notice from the sender vehicle 10 again in step S620.

### Second Control Module Carried Out by the Sender Vehicle 10

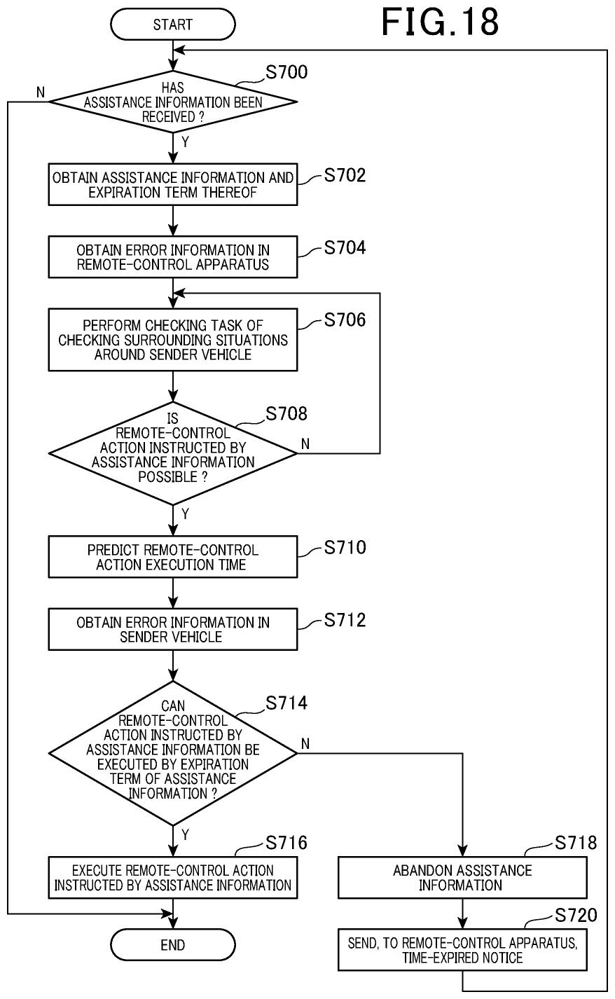

Next, the following describes a flow of the second control module of the remote-control routine carried out by the sender vehicle 10 according to the third embodiment with reference to FIG. 18.

Specifically, the sender vehicle 10 is configured to perform operations, which are identical to the corresponding operations according to the first embodiment, except for determination that the sender vehicle 10 is unable to execute the remote-control action instructed by the assistance information by the expiration term of the assistance information. Thus, description of the operations in steps S700 to S718 before an operation of abandoning the assistance information is omitted, because the operations in steps S700 to S718 are substantially identical to the operations in steps S300 to S318 illustrated in FIG. 12 of the first embodiment.

Following the operation in step S718 of abandoning the assistance information, the CPU 10A sends, to the remote-control apparatus 20A, a time-expired notice in step S720, returning to the operation in step S700.

In response to receiving the time-expired notice, the remote operator 32 enters new assistance information based on the latest vehicle condition information, so that the new assistance information is sent to the sender vehicle 10. This enables the CPU 10A of the sender vehicle to repeatedly perform the operation in step S700 and the subsequent operations in response to receiving the new assistance information.

Thus, upon determination that the CPU 10A is able to execute the remote-control action instructed by the new assistance information by the expiration term of the new assistance information, the CPU 10A executes the remote-control action instructed by the new assistance information in step S716, and thereafter terminates the second control module of the remote-control routine.

Like the first and second embodiments, the remote-control apparatus according to the third embodiment is configured to, under remote control of the remote operator 32 located at a distinct location, cause an assistance-request sender vehicle 10 to execute a remote-control action that the remote operator 32 is intended to execute.

The remote-control apparatus according to the third embodiment is additionally configured to generate, even if the situation around the assistance-request sender vehicle 10 is changed, new assistance information based on the changed situation around the assistance-request sender vehicle 10. This therefore makes it possible for the assistance-request sender vehicle 10 to execute the remote-control action that can respond to the actual situation around the assistance-request sender vehicle 10.

### Fourth Embodiment

The remote-control system of the second embodiment is configured to use the same determination method to thereby respectively determine the expiration term of the vehicle-condition information and the expiration term of the assistance information at the different times.

In contrast, a remote-control system of the fourth embodiment is configured to use different determination methods to thereby respectively determine the expiration term of the vehicle-condition information and the expiration term of the assistance information at the different times.

The configuration of the remote-control system of the fourth embodiment is substantially identical to that of the remote-control system of the second embodiment except that the method of determining the expiration term of the vehicle-condition information and the expiration term of the assistance information according to the fourth embodiment is different from that according to the second embodiment. Accordingly, the following describes only the different points of the remote-control system of the fourth embodiment as compared with the remote-control system of the second embodiment.

The CPU 20A of the fourth embodiment is configured to obtain a predetermined period from the generation time of the vehicle-condition information to the input time of the assistance information thereto, and subtract the predetermined period from the third valid period, i.e., the total valid period, to accordingly calculate the second valid period. Then, the CPU 20A is configured to determine the expiration term of the assistance information based on the determined second valid period. The first valid period can be freely calculated. Specifically, the first valid period can be calculated in the same manner as the second valid period or can be set to a predetermined constant period.

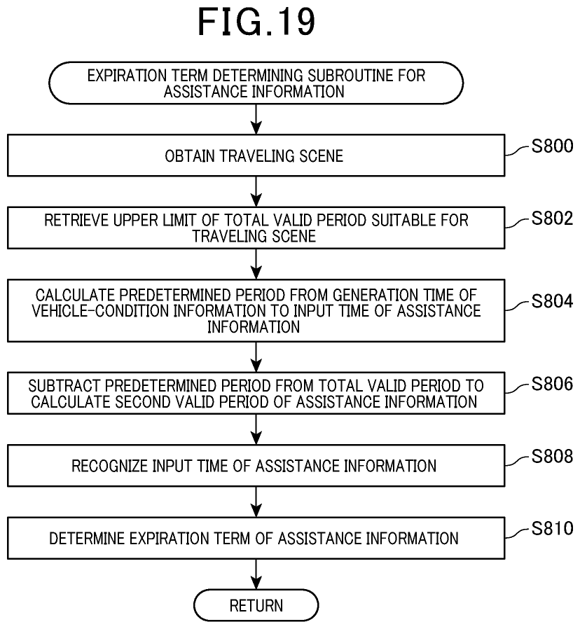

The expiration term determining subroutine for determining the second valid period is illustrated as a flowchart of FIG. 19.

Referring to FIG. 19, the CPU 20A obtains, from the received vehicle-condition packet of the sender vehicle 10, the determined traveling scene of the sender vehicle as a selected remote-control scene in step S800. Next, the CPU 20A refers to the table 90A, which represents a correlation between each traveling scene and the corresponding upper limit for the third valid period, to accordingly retrieve, from the table 90A, the upper limit of the third valid period, which correlates with the selected remote-control scene, thus determining the retrieved upper limit as the total valid period in step S802.

Next, the CPU 20A calculates the predetermined period from the generation time of the vehicle-condition information to the input time of the assistance information thereto in step S804. Then, the CPU 20A subtracts the predetermined period from the third valid period, i.e., the total valid period, to accordingly calculate the second valid period in step S806. For example, the CPU 20A calculates the second valid period of 400 ms assuming that the total valid period is 100 ms and the predetermined period is 600 ms.

Next, in step S808, the CPU 20A recognizes the input time of the assistance information determined in step S108. Then, the CPU 20A determines, based on the input time of the assistance information and the determined second valid period, the expiration term of the assistance information in step S810, and thereafter, terminates the expiration term determining subroutine, returning to the first control module of the remote-control routine.

Like the first to third embodiments, the remote-control apparatus according to the fourth embodiment is configured to, under remote control of the remote operator 32 located at a distinct location, cause an assistance-request sender vehicle 10 to execute a remote-control action that the remote operator 32 is intended to execute.

The remote-control apparatus according to the fourth embodiment is additionally configured to

(I) Subtract, from the total valid period, the predetermined period to accordingly calculate the second valid period

(II) Determine the expiration term of the assistance information based on the second valid period

This configuration results in the expiration term of the assistance information being determined within the total valid period.

### Fifth Embodiment

The remote-control system of the fifth embodiment is configured to perform a specific expiration-term determining method during (i) an emergency, such as the occurrence of an earthquake, and/or (ii) the occurrence of an anomaly associated with the remote-control system.

The configuration of the remote-control system of the fifth embodiment is substantially identical to that of the remote-control system of the first embodiment except that the remote-control system performs the specific expiration-term determining method during an emergency and/or the occurrence of an anomaly associated with the remote-control system. Accordingly, the following describes only the different points of the remote-control system of the fifth embodiment as compared with the remote-control system of the first embodiment while omitting the other points of the remote-control system of the fifth embodiment, which are identical to the corresponding points of the remote-control system of the first embodiment.

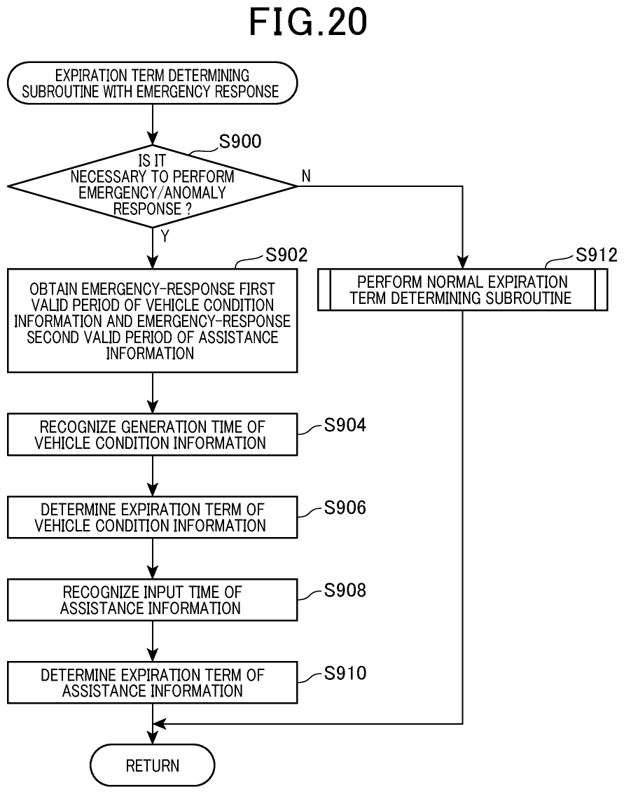

The CPU 20A of the fifth embodiment is configured to perform an expiration term determining subroutine with emergency response illustrated in FIG. 20 in place of the expiration term determining subroutine illustrated in step S112 of FIG. 7.

Referring to FIG. 20, the CPU 20A determines whether it is necessary to perform emergency/anomaly response in step S900. That is, the remote operator 32 determines whether it is necessary to perform emergency/anomaly response, and, when determining that it is necessary to perform an emergency/anomaly response, the remote operator 32 creates assistance information on which the determination that it is necessary to perform an emergency/anomaly response has been reflected. This therefore enables the CPU 20A to determine whether it is necessary to perform emergency/anomaly response in accordance with the contents of the assistance information.

Upon determination that it is necessary to perform emergency/anomaly response (YES in step S900), the expiration term determining subroutine proceeds to step S902. Otherwise, upon determination that it is unnecessary to perform an emergency/anomaly response (NO in step S900), the expiration term determining subroutine proceeds to step S912.

In step S902, the CPU 20A obtains an emergency-response first valid period of the vehicle-condition information, and an emergency-response second valid period of the assistance information. The assistance information, which instructs each vehicle 10 to perform an action in response to the occurrence of an emergency and/or an anomaly associated with the remote-control system, is required to be reliably sent to each vehicle 10. For this reason, each of the emergency-response first valid period of the vehicle-condition information, and the emergency-response second valid period of the assistance information is set to be longer than the corresponding normal first valid period of the vehicle-condition information and the normal second valid period of the assistance information. This can prevent each of the emergency-response first and second valid periods from being abandoned due to out-of-expiration of the corresponding one of the emergency-response first and second valid periods.

Following the operation in step S902, the CPU 20A recognizes the generation time of the vehicle-condition information extracted in step S102 in step S904. Then, the CPU 20A determines, based on the generation time of the vehicle-condition information and the emergency-response first valid period, the expiration term of the vehicle-condition information in step S906.

Next, the CPU 20A recognizes the input time of the assistance information determined in step S108 in step S908. Then, the CPU 20A determines, based on the input time of the assistance information and the emergency-response second valid period, the expiration term of the assistance information in step S910, and thereafter terminates the expiration term determining subroutine, returning to the first control module of the remote-control routine.

Otherwise, upon determination that it is unnecessary to perform emergency/anomaly response (NO in step S900), the CPU 20A performs a normal expiration term determining subroutine, which is for example illustrated in FIG. 11, in step S912, and thereafter terminates the expiration term determining subroutine.

Like the first to forth embodiments, the remote-control apparatus according to the fifth embodiment is configured to, under remote control of the remote operator 32 located at a distinct location, cause an assistance-request sender vehicle 10 to execute a remote-control action that the remote operator 32 is intended to execute.

The remote-control apparatus according to the fifth embodiment is additionally configured to, upon determination that it is necessary to perform emergency/anomaly response, determine the expiration term of each of the vehicle condition information and the assistance information to be longer to accordingly prevent the assistance information from being abandoned due to out-of-expiration. The above configuration of the remote-control apparatus according to the fifth embodiment makes it possible to reliably send, to each vehicle 10, the assistance information that instructs the corresponding vehicle 10 to perform emergency/anomaly response in accordance with the contents of the assistance information.

### Modifications

The first to fifth exemplary embodiments, each of which includes the corresponding remote-control apparatus, the corresponding remote-control vehicles, the corresponding remote-control system, and the corresponding remote-control program, have been described, but the present disclosure is not limited to the above first to fifth exemplary embodiments. Various modifications and/or improvements can be applied to each of the first to fifth exemplary embodiments within the patentable concept of the present disclosure, and therefore, the first to fifth exemplary embodiments to each of which Various modifications and/or improvements have been applied are included in the scope of the present disclosure.

For example, at least two of the first to fifth embodiments can be combined with each other.

Each sequence of operations (steps) in a corresponding computer program is an example of various sequences of operations, and therefore one or more unnecessary operations (steps) can be eliminated within the scope of the corresponding sequence. One or more new operations (steps) can be added to each sequence within the scope of the corresponding sequence, and/or the order of some operations (steps) in each sequence can be changed within the scope of the corresponding sequence.

The above routines described in each exemplary embodiment are implemented by means of software, so that a computer of each exemplary embodiment is configured to execute one or more computer programs to thereby implement the above routines described in the corresponding embodiment. The present disclosure is however not limited to this configuration.

Specifically, the above routines described in each exemplary embodiment can be implemented by means of, for example, hardware or the combination of software and hardware.

Like the CPU according to each exemplary embodiment, at least one of various processors can be configured to load and execute the software programs. These various processors can include (i) programmable logic-device (PLD) processors, such as field-programmable gate-array (FPGA) processors, and (ii) dedicated electrical-circuitry processors, such as application specific integrated circuits (ASICs), each of which has a circuit configuration designed to specially execute the above routines.

Each software program can be carried out by any of the various processors or the combination of the same type of processors included in the various processors, such as plural FPGA processors, or the combination of the different types of processors included in the various processors, such as the combination of a CPU and an FPGA processor.

Each of the various processors can have a hardware configuration, such as an electric-circuit configuration comprised of circuit elements, for example, semiconductor elements.

Each computer program set forth above has been installed, i.e., stored, in the storage unit according to each exemplary embodiment, but the present disclosure is not limited thereto.

Specifically, each computer program can be stored in a non-transitory storage media, and executing each computer program carries out the routine implemented by the corresponding computer program. Each computer program can be offered in the form of being stored in a non-transitory storage media, such as a computer disk read only memory (CD-ROM), a digital versatile disk read only memory (DVD-ROM), a universal serial bus (USB) memory, or a semiconductor memory. Each compute program can be downloaded from an external device through a network to at least one processor.

While the illustrative embodiments of the present disclosure have been described herein, the present disclosure is not limited to the embodiments and their configurations described herein. Specifically, the present disclosure includes various modifications and/or alternatives within the scope of the present disclosure. In addition to various combinations and forms, other combinations and forms including one or more/less elements thereof are also within the inventive principle and scope of the present disclosure.

1. A remote-control apparatus comprising:
a receiver configured to receive, from a vehicle, vehicle condition information representing a condition of the vehicle and a surrounding condition around the vehicle;
an accepting unit configured to:
present the vehicle condition information to a remote operator; and
accept assistance information for remote assistance of the vehicle inputted by the remote operator;
a determiner configured to determine an expiration term of the assistance information, the expiration term of the assistance information being defined as an end time of an assistance-information valid period that has started since an input time of the assistance information; and
a sender configured to send, to the vehicle, the assistance information and the expiration term of the assistance information.

2. A remote-control apparatus comprising:
a receiver configured to receive, from a vehicle, (i) vehicle condition information representing a condition of the vehicle and a surrounding condition around the vehicle, and (ii) a generation time of the vehicle condition information;
an accepting unit configured to:
present the vehicle condition information to a remote operator; and
accept assistance information for remote assistance of the vehicle inputted by the remote operator;
a determiner configured to determine:
a first expiration term of the vehicle condition information, the first expiration term of the vehicle condition information being defined as an end time of a first valid period that has started since the generation time of the vehicle condition information;
a second expiration term of the assistance information, the second expiration term of the assistance information being separated from the first expiration term of the vehicle condition information and defined as an end time of a second valid period that has started since an input time of the assistance information; and
a sender configured to send, to the vehicle, the assistance information and the second expiration term of the assistance information upon determination that the assistance information has been inputted to the remote-control apparatus by the first expiration term.

3. The remote-control apparatus according to claim 1, wherein:
the determiner is configured to perform one of a first measure and a second measure,
the first measure being configured to:
extract, from a correlation between items of a single expiration-term variation factor and corresponding respective values of the assistance information valid period, a value of the assistance information valid period that is suitable for the vehicle condition information; and
determine the expiration term of the assistance information based on the extracted value of the assistance information valid period,
the second measure being configured to:
extract, from correlations between items of each expiration-term variation factor and corresponding respective values of the assistance information valid period, values of the assistance information valid period for the respective correlations, the values of the assistance information valid period that are suitable for the vehicle condition information;
select one of the values of the assistance information valid period that is the shortest in all the values of the assistance information valid period; and
determine the expiration term of the assistance information based on the selected shortest value of the assistance information valid period.

4. The remote-control apparatus according to claim 2, wherein:
the determiner is configured to perform, for each of the first and second expiration terms, one of a first measure and a second measure,
the first measure being configured to:
extract, from a correlation between items of a single expiration-term variation factor and corresponding respective values of the first valid period, a value of the first valid period that is suitable for the vehicle condition information;
determine the first expiration term of the vehicle condition information based on the extracted value of the first valid period;
extract, from a correlation between items of the single expiration-term variation factor and corresponding respective values of the second valid period, a value of the second valid period that is suitable for the vehicle condition information;
determine the second expiration term of the assistance information based on the extracted value of the second valid period;
the second measure being configured to:
extract, from correlations between items of each expiration-term variation factor and corresponding respective values of the first valid period, values of the first valid period for the respective correlations, the values of the first valid period that are suitable for the vehicle condition information;
select one of the values of the first valid period that is the shortest in all the values of the first valid period;
determine the first expiration term of the vehicle condition information based on the selected shortest value of the first valid period;
extract, from correlations between items of each expiration-term variation factor and corresponding respective values of the second valid period, values of the second valid period for the respective correlations, the values of the second valid period that are suitable for the vehicle condition information;
select one of the values of the second valid period that is the shortest in all the values of the second valid period;
determine the second expiration term of the vehicle condition information based on the selected shortest value of the second valid period.

5. The remote-control apparatus according to claim 3, wherein:
the single expiration-term variation factor or the expiration-term variation factors include at least one of:
(I) which of traveling scenes determined by the vehicle;
(II) which of remote-control action contents inputted by the remote operator;
(III) a length of a cancellation period for which a remote-control action instructed by the assistance information is cancellable;
(IV) a length of a margin time previously determined for the remote-control action;
(V) an extent of a change of the surrounding condition around the vehicle; and
(VI) a length of a time to collision calculated for the vehicle.

6. The remote-control apparatus according to claim 2, wherein:
the determiner is configured to:
obtain a third valid period that represents a period for which the remote-control action based on the assistance information is executable; and
subtract the second valid period from the third valid period to accordingly calculate the first valid period.

7. The remote-control apparatus according to claim 2, wherein:
the determiner is configured to:
obtain a third valid period that represents a period for which the remote-control action based on the assistance information is executable;
obtain a predetermined period from the generation time of the vehicle-condition information to the input time of the assistance information; and
subtract the predetermined period from the third valid period to accordingly calculate the second valid period.

8. The remote-control apparatus according to claim 6, wherein:
the vehicle condition information incudes a selected one of the traveling scenes; and
the determiner is configured to extract, from a correlation between each traveling scene to be determined by the vehicle and a corresponding value of the third valid period, a value of the third valid period that is suitable for the selected one of the traveling scenes.

9. The remote-control apparatus according to claim 1, wherein:
the determiner is configured to determine, during an emergency and/or an occurrence of an anomaly associated with the remote-control apparatus, a first predetermined expiration term for an emergency/anomaly response as the expiration term of the vehicle condition information, and a second predetermined expiration term for the emergency/anomaly response as the expiration term of the assistance information.

10. The remote-control apparatus according to claim 2, wherein:
the sender is configured to abandon the assistance information upon determination that the assistance information has not been inputted to the remote-control apparatus by the first expiration term.

11. The remote-control apparatus according to claim 2, wherein:
the accepting unit is configured to send, to the remote operator, a time-expired notice of the expiration term of the vehicle condition information upon determination that the assistance information has not been inputted to the remote-control apparatus by the first expiration term.

12. The remote-control apparatus according to claim 1, wherein:
the sending unit is configured to send
the accepting unit is configured to accept new assistance information from the remote operator based on a latest item of the vehicle condition information after sending, to the remote operator, a time-expired notice of the expiration term of each of the vehicle condition information and the assistance information.

13. The remote-control apparatus according to claim 2, further comprising:
a determining unit configured to determine whether the assistance information has been inputted to the remote-control apparatus by the first expiration term,
wherein:
the receiver is configured to receive, together with the vehicle condition information and the generation time of the vehicle condition information, a synchronous error in the vehicle;
the determining unit is configured to determine, while taking into account both the synchronous error in the vehicle and a synchronous error in the remote-control apparatus, whether the assistance information has been inputted to the remote-control apparatus by the first expiration term; and
the sender is configured to send, to the vehicle, (i) the assistance information, (ii) the second expiration term of the assistance information, and (iii) the synchronous error in the remote-control apparatus.

14. The remote-control apparatus according to claim 1, wherein:
the remote-control apparatus performs packet communications with the vehicle; and
information representing or associated with the expiration information and a determination target of the expiration information are communicated while being stored in a packet.

15. The remote-control apparatus according to claim 14, wherein:
information representing the generation time of the vehicle condition information and the vehicle condition information are received while being stored in a first selected packet as the packet; and
information representing the expiration term of the assistance information and the assistance information are sent while being stored in a second selected packet as the packet.

16. The remote-control apparatus according to claim 14, wherein:
information representing a synchronous error in the vehicle and the vehicle condition information are received while being stored in a third selected packet as the packet; and
information representing a synchronous error in the remote-control apparatus is sent while being stored in a fourth selected packet as the packet.

17. A remote-controlled vehicle comprising:
a sender configured to send, to a remote-control apparatus, vehicle condition information representing a condition of the remote-controlled vehicle and a surrounding condition around the remote-controlled vehicle;
a receiver configured to receive, from the remote-control apparatus, (i) assistance information for remote assistance of the remote-controlled vehicle inputted by a remote operator; and (ii) an expiration term of the assistance information, the expiration term of the assistance information being defined as an end time of an assistance-information valid period that has started since an input time of the assistance information; and
an executing unit configured to execute a remote-control action instructed by the assistance information upon determination that the remote-control action instructed by the assistance information has been executable by the expiration term of the assistance information.

18. The remote-controlled vehicle according to claim 17, wherein:
the executing unit is configured to, upon determination that the remote-control action instructed by the assistance information has not been executable by the expiration term of the assistance information, abandon the assistance information before execution of the remote-control action instructed by the assistance information.

19. The remote-controlled vehicle according to claim 17, wherein:
the sender is configured to send, to the remote-control apparatus, a time-expired notice of the expiration term of the assistance information.

20. The remote-controlled vehicle according to claim 17, wherein:
the sender is configured to send, to the remote-control apparatus, one of:
a generation time of the vehicle condition information; and
an expiration term of the vehicle condition information.

21. The remote-controlled vehicle according to claim 17, further comprising:
a determiner configured to determine whether the remote-controlled vehicle is able to execute the remote-control action instructed by the assistance information by the expiration term of the assistance information,
wherein:
the receiver is configured to receive, from the remote-control apparatus, a synchronous error in the remote-control apparatus together with the assistance information; and
the determining unit is configured to determine, while taking into account both the synchronous error in the remote-control apparatus, and a synchronous error in the vehicle, whether the remote-controlled vehicle is able to execute the remote-control action instructed by the assistance information by the expiration term of the assistance information.

22. A remote-control system comprising:
a remote-control apparatus according to claim 1; and
a remote-controlled vehicle according to claim 17.

23. A program product for a processor, the program product comprising:
a non-transitory computer-readable medium; and
a set of computer program instructions embedded in the computer-readable medium, the instructions causing the processor to:
receive, from a vehicle, vehicle condition information representing a condition of the vehicle and a surrounding condition around the vehicle;
present the vehicle condition information to a remote operator;
accept assistance information for remote assistance of the vehicle inputted by the remote operator;
determine an expiration term of the assistance information, the expiration term of the assistance information being defined as an end time of an assistance-information valid period that has started since an input time of the assistance information; and
send, to the vehicle, the assistance information and the expiration term of the assistance information.
